(19) United States
(12) Patent Application Publication
(10) Pub. No.: US 2008/0183508 A1
(43) Pub. Date: Jul. 31, 2008

(54) Methods for Real-Time Underwriting

(76) Inventors: Phillip E. Harker, Draper, UT (US); Stephen C. Pranke, Holladay, UT (US); James A. Minnich, Dayton, MN (US)

Correspondence Address: FULBRIGHT & JAWORSKI L.L.P., 600 CONGRESS AVE., SUITE 2400, AUSTIN, TX, 78701, US

(21) Appl. No.: 12/022,748

(22) Filed: Jan. 30, 2008

Related U.S. Application Data
(60) Provisional application No. 60/887,301, filed on Jan. 30, 2007.

(51) Int. Cl. G06Q 40/00

(52) U.S. Cl. 705/4

(57) ABSTRACT

Methods for providing substantially real-time quotes are provided. In one respect, a method may receive from a potential customer authorization to access at least the potential customer's pharmacy profile. The pharmacy profile may be retrieved and a risk score may be generated as a function of the pharmacy profile. A quote may be generated based on the risk and may be provided to the potential customer at substantially real-time.

### CROSS-REFERENCE TO RELATED APPLICATIONS

This application claims the priority of U.S. Provisional Patent Application Ser. No. 60/887,301, filed Jan. 30, 2007, the entire disclosure of which is specifically incorporated herein by reference.

### BACKGROUND OF THE INVENTION

1. Field of the Invention

The present invention relates generally to underwriting insurance policy. More particularly, it concerns mining and analyzing medical and/or prescription data for real-time or substantially real-time rating, underwriting, and policy issuance, and in particular, mortality (life) insurance.

2. Description of Related Art

Insurance underwriting generally involves collecting past and present medical conditions to determine a risk and issuing a policy based on that risk. Current techniques involve an underwriter meeting with a potential customer or existing customer (looking to renew) to conduct medical interviews and filing of an insurance application. The technique may also include doctor, nurses, or medical technicians performing a medical examination.

Upon the completion of the medical exams and interview, the application may be compared against underwriting standards set by insurance companies. The insurance application may be classified into a risk category available for a type of insurance coverage requested by an applicant, where the risk categories affect a premium paid by the applicant, e.g., the higher the risk category, the higher the premium. A decision to accept or reject the application for insurance may also be part of this risk classification, as risks above a certain tolerance level set by the insurance company may be rejected.

While the current technique provides some benefits, it suffers from many disadvantages. For example, during the interview process, a potential or existing customer may hide or forget pertinent information or facts about his or her medical conditions, and thus, may ultimately cost insurance companies financial losses.

Additionally, the process from filling out the application and providing a quote for insurance rates may take upwards of 2 to 3 weeks. Certain steps, including verification of the information provided on the application, scheduling the medical examination, and evaluation of the application are usually performed by humans and thus, time consuming. Below, several U.S. patent applications that are representative of methods to overcome conventional techniques are briefly discussed. Although each of these references has shown at least a degree of success in its respective application, room for significant improvement remains.

U.S. Patent Application Publication No. 2005/0108062, incorporated by reference herein in its entirety, is directed to an automated underwriting technique. Self-reported information, including age, address, citizenship, medical history, family medical history, nicotine usage, alcohol usage, drug usage, and/or any hazardous activity involvement are provided by a potential customer using an input device (e.g., computer or other input terminals). Additionally, objective information such as height, weight, blood pressure, cholesterol, glucose level, drug and/or tobacco usage, and the like are also provided by the potential customer. The self-reported and objective information is collected and evaluated using an underwriting software program which subsequently provides a quote to the potential customer. While this technique may be faster with the use of the software program, issues such as accuracy in the information provided by the potential customer (e.g., medical history, family medical history, and the like) is still an issue.

U.S. Patent Application Publication No. 2002/0091550, incorporated by reference herein in its entirety, is directed to rating, underwriting, and policy issuance in real-time or substantially real-time. In one respect, an insurance application may be provided to a potential customer electronically or via an automated telephone or facsimile system. The potential customer may provide information relating to his or her identity as well as past insurance information and the like. The information provided may be transmitted for verification and a rate may be provided in substantially real-time. However, similar to the disadvantages of U.S. Patent Application Publication No. 2005/0108062, the rate of a policy is based on the information provided by the potential customer which may be inaccurate or incomplete. Therefore, disadvantages such as fraud and potential financial losses to an insurance company may increase.

The referenced shortcomings of conventional methodologies mentioned above are not intended to be exhaustive, but rather are among many that tend to impair the effectiveness of previously known techniques concerning the underwriting process. Other noteworthy problems may also exist; however, those mentioned here are sufficient to demonstrate that the methodologies appearing in the art have not been altogether satisfactory and that a significant need exists for the techniques described and claimed here.

### SUMMARY OF THE INVENTION

Techniques disclosed here may be used to improve underwriting, and in particular, providing real-time or substantially real-time quotes for insurance coverage rates to potential customers. These techniques utilize past pharmacy claim data to generate an accurate health status and risk score. Additionally, the these techniques may also utilize lab results, medical history information, and/or credit information to determine a risk score.

In exemplary embodiments, a quote is a set of input data and calculated data for a single group. As discussed in more detail below, a quote may be linked to an automated rating engine's formula module which may be used to calculate rates and other results for the quote. A single quote may calculate the rates for multiple subgroups within the group. In certain embodiments, a quote may be a monetary value requested in exchange for services such as insurance coverage. In a particular embodiment, a quote is an estimate of the price or costs for providing health insurance to a group or individual.

Certain exemplary embodiments may comprise a method for underwriting comprising receiving authorization from a customer for access to predictive data, retrieving the predictive data, generating a risk score based on the predictive data, generating a substantially real-time quote based on the risk score, and providing the substantially real-time quote to the customer. In certain embodiments, the predictive data comprises at least one of: pharmacy profile information, lab profile information, and credit information.

In certain embodiments, the predictive data comprises pharmacy profile information and lab profile information, while in others, the predictive data comprises pharmacy profile information and credit information or lab profile information and credit information.

Certain embodiments comprise a program storage device readable by a machine, tangibly embodying a program of instructions executable by the machine to perform steps of exemplary methods.

Exemplary embodiments may also comprise a method for underwriting comprising receiving authorization to access a pharmacy profile from a customer, retrieving the pharmacy profile, generating a substantially real-time quote based on the pharmacy profile, and providing the substantially real-time quote to the customer.

Specific embodiments may comprise generating a risk score based on the pharmacy profile information and generating the substantially real-time quote based on the risk score. In certain embodiments, generating the risk score comprises using a predictive modeling tool to generate the risk score. Exemplary embodiments may also comprise receiving authorization from the customer to access medical history information.

In certain embodiments, generating the substantially real-time quote may further comprise generating the substantially real-time quote based on the medical history information. Still other embodiments may further comprise receiving authorization from the customer to access credit history information.

In specific embodiments, the substantially real-time quote further comprises generating the substantially real-time quote based on the credit history information. Other embodiments may comprise receiving authorization from the customer to access lab profile information.

In still other embodiments, generating the substantially real-time quote further comprises generating the substantially real-time quote based on the lab profile information. Specific embodiments may further comprise receiving a questionnaire from the patient. In still more specific embodiments, generating the substantially real-time quote may further comprise generating the substantially real-time quote based on the questionnaire.

The term “potential customer” as defined and used in this disclosure refers to an individual seeking insurance coverage. The potential customer may be a new customer or an existing customer renewing a policy. The customer may be an individual or a group of individuals in a work place seeking a group insurance plan. In some respects, the potential customer may be a company seeking insurance benefits for its employees. Alternatively, the potential customer may be an individual seeking insurance policy in addition to or instead of a group insurance plan, such as a policy through a workplace. The potential customer may also be an individual seeking family insurance coverage (e.g., self and spouse and/or one or more child).

The terms “a” and “an” are defined as one or more unless this disclosure explicitly requires otherwise.

The term “approximately” and its variations are defined as being close to as understood by one of ordinary skill in the art, and in one non-limiting embodiment the terms are defined to be within 10%, preferably within 5%, more preferably within 1%, and most preferably within 0.5%. The term “substantially” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

The term “coupled,” as used herein, is defined as connected, although not necessarily directly, and not necessarily mechanically.

Other features and advantages will become apparent with reference to the following detailed description of specific, example embodiments in connection with the accompanying drawings.

### BRIEF DESCRIPTION OF THE DRAWINGS

The following drawings form part of the present specification and are included to further demonstrate certain aspects of the present invention. The drawings do not limit the invention but simply offer examples.

FIG. 1 illustrates a flowchart for a method for substantially real-time underwriting, in accordance with embodiments of the disclosure.

FIG. 2 illustrates an exemplary embodiment of communication between automated rated engine 100 and other components.

FIG. 3 illustrates, accordance with embodiments of the disclosure, the interaction between each server component in a single-server installation is shown.

FIG. 4 illustrates, in accordance with embodiments of the disclosure, communication between components of various components.

FIG. 5 illustrates, in accordance with embodiments of the disclosure, communication between components of various components.

FIG. 6 illustrates, in accordance with embodiments of the disclosure, differences between sessions based methods and single call methods.

FIG. 7 illustrates, in accordance with embodiments of the disclosure, one example of source code used to create a new quote.

FIG. 8 illustrates, in accordance with embodiments of the disclosure, one example of source code used to update an existing quote.

FIG. 9 illustrates, in accordance with embodiments of the disclosure, one example in which criteria nodes can be used to pass criteria to a stored procedure that finds a quote.

FIG. 10 illustrates, in accordance with embodiments of the disclosure, one example of source code used to create a new quote.

FIG. 11 illustrates, in accordance with embodiments of the disclosure, one example of source code used for inbound integration calls into the automated rating engine that can allow applications to update the number of subgroups.

FIGS. 12-15 illustrate, in accordance with embodiments of the disclosure, examples of source code that can be used to update step values, update or add table data (adding rows via the legacy method or new table actions), and update table row contents.

FIG. 16 illustrates, in accordance with embodiments of the disclosure, a quote summary.

FIG. 17 illustrates, in accordance with embodiments of the disclosure, components of a predictive modeling tool.

FIG. 18-19 illustrate, in accordance with embodiments of the disclosure, a member profile.

FIG. 20 illustrates, in accordance with embodiments of the disclosure, activities performed by the predictive modeling tool.

FIG. 21 illustrates, in accordance with embodiments of the disclosure, high level risk processing.

FIG. 22 illustrates, in accordance with embodiments of the disclosure, more detailed level risk processing.

FIG. 23 illustrates, in accordance with embodiments of the disclosure, describes and compares some of the risk models available to the predictive modeling tool.

FIG. 24 illustrates, in accordance with embodiments of the disclosure, a standard risk model timeline diagram.

FIG. 25 illustrates, in accordance with embodiments of the disclosure, major practice categories.

FIG. 26 illustrates, in accordance with embodiments of the disclosure, one example of the family of markers for Congestive heart failure.

FIG. 27 illustrates, in accordance with embodiments of the disclosure, an example of the computation of risk for a member. an exemplary list of the risk measures, or scores, that the Standard risk model can provide as outputs.

FIG. 28 illustrates, in accordance with embodiments of the disclosure, an exemplary list of the risk measures, or scores, that the Standard risk model can provide as outputs.

FIG. 29 illustrates, in accordance with embodiments of the disclosure, an actuarial/underwriting (A/U) model used for providing risk scores for the underwriting practice.

FIG. 30 illustrates, in accordance with embodiments of the disclosure, that processing tasks may also include an output of risk profile or risk measures.

FIG. 31 illustrates, in accordance with embodiments of the disclosure, an example of the risk measure, or score, that the age-sex risk model provides as outputs.

FIG. 32 illustrates, in accordance with embodiments of the disclosure, an example of the risk measures, or scores, that the TOS risk model provides as outputs.

FIG. 33 illustrates, in accordance with embodiments of the disclosure, an example of how to calculate PRG risk for an individual of a member population.

FIG. 34 illustrates, in accordance with embodiments of the disclosure, an example of how to calculate PRG risk for an individual of a member population.

FIG. 35 illustrates, in accordance with embodiments of the disclosure, an example of how to calculate PRG risk for an individual of a member population.

FIG. 36 illustrates, in accordance with embodiments of the disclosure, examples of some of the lab-based markers of risk used by the predictive modeling tool lab risk model.

FIG. 37 illustrates, in accordance with embodiments of the disclosure, One example of the risk scores assigned to a member using the Lab risk model.

FIG. 38 illustrates, in accordance with embodiments of the disclosure, the member's risk measures in the Risk Information section of the member profile.

### DESCRIPTION OF ILLUSTRATIVE EMBODIMENTS

This disclosure and the various features and advantageous details of its subject matter are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

Embodiments of this disclosure allow for medical underwriting techniques that provide near real-time or real-time quotes based on factors such as medical and/or pharmaceutical histories of potential customer(s). Embodiments of this disclosure minimizes the human involvement in the underwriting process while improving the speed and accuracy of the verification process of an application, thereby reducing or substantially eliminating the financial losses to insurance provider due to fraudulent or incomplete applications.

In one respect, the disclosure provides utilizing prescription profiling methodologies, predictive modeling, an analytical tool that determines information about the health status of the potential customer, and an automated rating technique to generate quotes. Detailed descriptions of each of these are provided below.

### Prescription Profiling

Prescription information may be used to accurately determine the past and present medical history of a potential customer. For example, the prescription information may include, without limitation, prescription drug claim, insurance eligibility information (as well as a member pharmaceutical benefit history), prescribing physician, possible diagnoses, possible side effects, and/or a predictive risk assessment for a given patient.

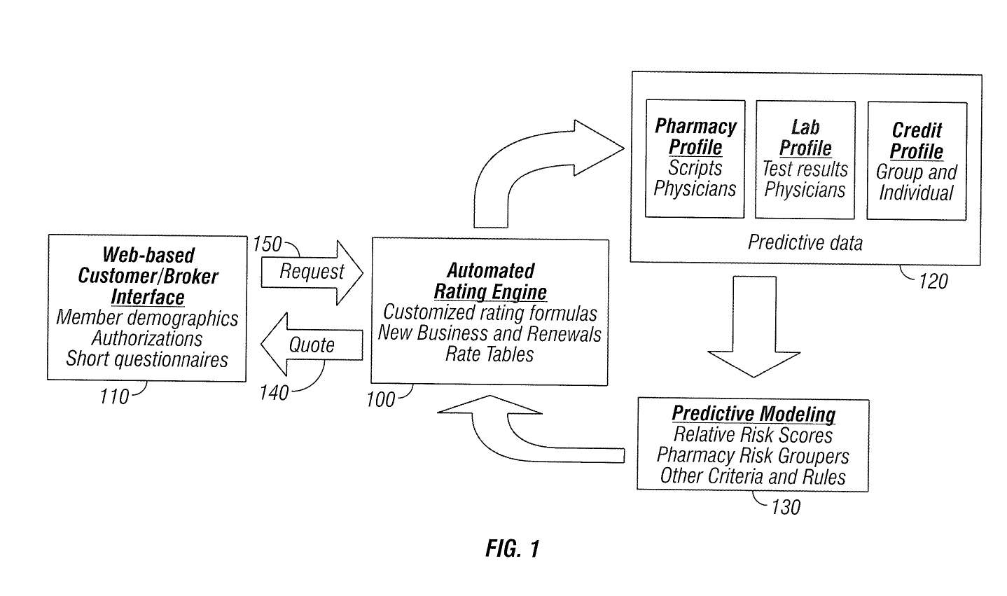

Referring to FIG. 1, a potential customer may provide information and issue a request 150 for a quote 140 to an automated rating engine 100 via an interface 110 (e.g., graphical user interface, GUI) on a client device such as, but not limited to, a computer. The interface 110 may present questions to potential customer and enables the potential customer to input data using an input device (e.g., mouse, keyboard, microphone, etc.). In one respect, the information provided may include authorization to access pharmacy, laboratory, and/or medical information. Additionally, the information may include authorization to access the credit history of the potential customer.

In addition to the request for quote and authorization information, the potential customer may provide, for example, demographic information. This information may include identity information, such as, but not limited to, name, address, contact phone numbers, marital status, date of birth, and social security number. Other information including, without limitation, employment information, primary care physician, current medical insurance coverage, and the like may be provided by the potential customer.

Alternatively or in addition to the above, the potential customer may be prompted by the interface with a few questions. In one respect, the potential customer may answer questions relating health risk, family medical history, and the like.

The data (e.g., answers to the questions, quote request, and authorization information) may be sent with applicable security measures as governed by privacy and confidentiality regulations, including, for example, the Health Insurance Portability and Accountability Act (HIPAA). In some embodiments, the request and authorization may be encrypted during the transmission.

### Automated Rating Engine

Any of the above information provided by the potential customer may be transmitted to automated rating engine 100 via a wireless or wired connection. In one embodiment, the information may be stored in a memory device such as, but is not limited to, a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc.

Alternatively or in addition to, the information may be manipulated. For example, in one embodiment, data corresponding to the potential customer including, without limitation, the name, social security number, address, and the like may be parsed from the data received by the automated rating engine. The data may be used for locating, in one embodiment, the potential customer's pharmacy profile, lab profile, and/or credit profile (collectively referred to as the predictive data 120, as referenced in FIG. 1) from respective databases.

The automated rating engine may include one or more applications configured to automate underwriting techniques. Alternatively or in addition to, the automated rating engine may also manage blocks of business for health plans of all size.

In one embodiment, automated rating engine 100 may include a processor. The processor may be any computer-readable media known in the art. Alternatively or in addition to, the processor may be any computing device capable of executing instructions. In one embodiment, the processor may be part of a personal computer (e.g., a typical desktop or laptop computer operated by a user). In another embodiment, the processor may be part of a personal digital assistant (PDA) or other handheld computing device.

In some embodiments, the processor may be part of a networked device and may involve a terminal device running software from a remote server, wired or wirelessly. Input from a user or other system component may be gathered through one or more known techniques such as a keyboard and/or mouse. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash drive, USB drive, or the like. The processors may use any type of monitor or screen known in the art, for displaying information, such as but not limited to, pharmacy profile, credit history, risk scores, medical information, current insurance coverage, and the like. For example, a cathode ray tube (CRT) or liquid crystal display (LCD) can be used. One or more display panels may also constitute a display. In other embodiments, a traditional display may not be required, and the processor may operate through appropriate voice and/or key commands.

### Predictive Modeling

Referring now to FIG. 1, in one embodiment, pharmacy profile data, lab profile data, and/or credit information collected may be provided to a predictive modeling tool 130 for determining the health status and future risks of the potential customer. It is noted that the above listed datasets are non-exemplary and that other information, such as, but not limited to, medical claims data, medical records, and the like, may be used to determine the health status and potential future risks.

Predictive modeling tool 130 may include analytic tools, and in particular, predictive models. In one embodiment, the analytic tools may be a rule-based predictive modeling platform.

In addition to the analytic tools or alternatively, predictive modeling tool 130 may include perform a risk assessment method. The risk assessment method may be based on industry standards such as the Episode Risk Groups (ERGs) and/or the Pharmacy Risk Groups (PRGs) that may identify key markers of risk, including, without limitation, clinical conditions, and prior events. In certain embodiments, a risk score may be generated based on the predictive data provided to predictive modeling tool 130. The risk score may then be used as a factor in generating a quote 140 for the customer.

### Real-Time Underwriting Quotes

Using the results from at least predictive modeling tool 130 and automated rating engine 100, a substantially real-time quote 140 is provided to the potential customer, as shown in FIG. 1.

### Automated Rating Engine Communication

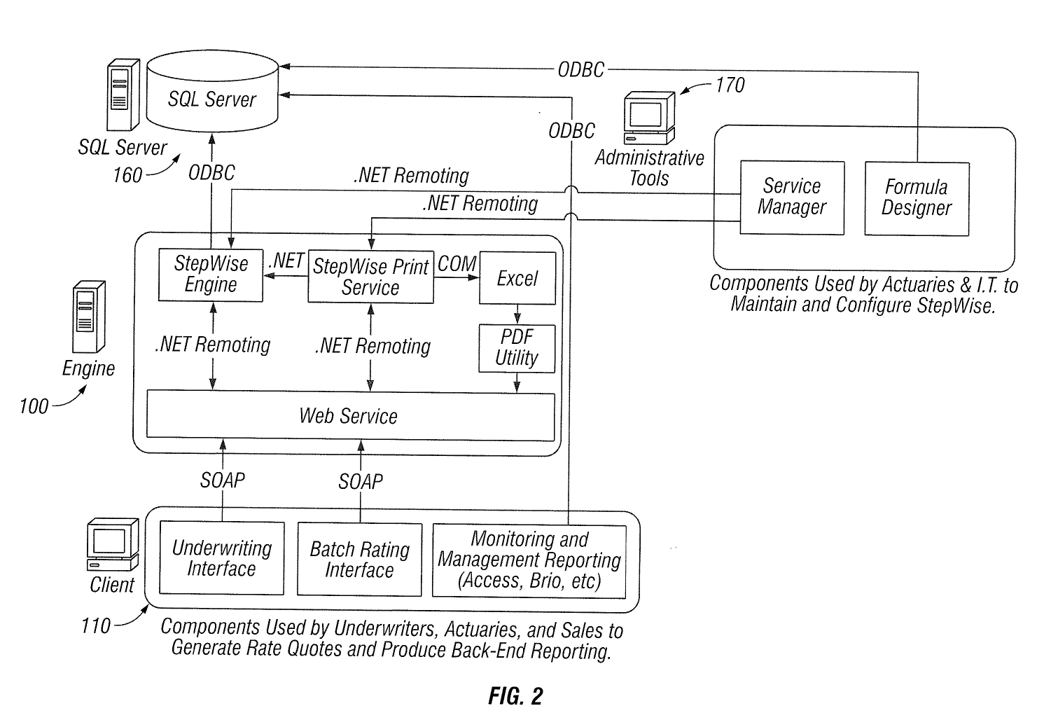

One exemplary embodiment of communication between automated rated engine 100 and other components in the system is shown in FIG. 2. As shown, the client makes calls to a web server via client interface 110 through SOAP (Simple Object Access Protocol) requests, sending and receiving XML data. The web server is running a web service, which is an application that allows the calling of functions through http requests. The functions return to the client as XML, again across a SOAP connection. The automated rating engine service and the automated rating engine 100 print service both open TCP ports for remote calls, which may allow function calls to be made to a remote server across a TCP/IP connection. The automated rating engine remote connection is used to communicate with the web service, as well as communicating with the automated rating engine's Service manager. The Print service uses a remote connection on a separate port to receive print requests from the web service.

The automated rating engine 100 may communicate directly with an SQL server 160 for the following functions: (a) retrieving configuration information, including formulas, factor tables, and user information; (b) creating, saving, and re-opening quotes; (c) retrieving group (and other) information from the plan's production systems. Calls made to SQL Server 160 from the automated rating engine 100 may be done as the engine account (in certain exemplary embodiments, no impersonation is done). SQL Server 160 may also communicate directly with the database to retrieve information about the exhibits to be printed. SQL Server calls may be made at the time the engine is loaded, and calls may be made using the account under which the Print Service is running. In certain exemplary embodiments, no impersonation is performed.

Certain embodiments may also comprise administrative tools 170 (including a Service Manager) that may retrieve and set user information, permission information, and configuration information from the database. The Service Manager may call SQL Server 160 using the credentials of the user running the application.

Administrative tools 170 may also comprise a Formula Designer that may retrieve and modify step information, tables, formulas and client layout information. The Formula Designer may also call SQL Server 170 using the credentials of the user running the application.

Automated rating engine 100 may be developed using Microsoft .NET technology and as such runs on Windows servers with the .NET framework installed. One of ordinary skill in the art can recognize other suitable platforms may also be used. Server components include two Windows services, a Web Service, and an ASP.NET Web Application. Exemplary embodiments may comprise a Microsoft SQL Server, however, automated rating engine 100 supports using any ODBC compliant database back-end, including Oracle, DB2, etc.

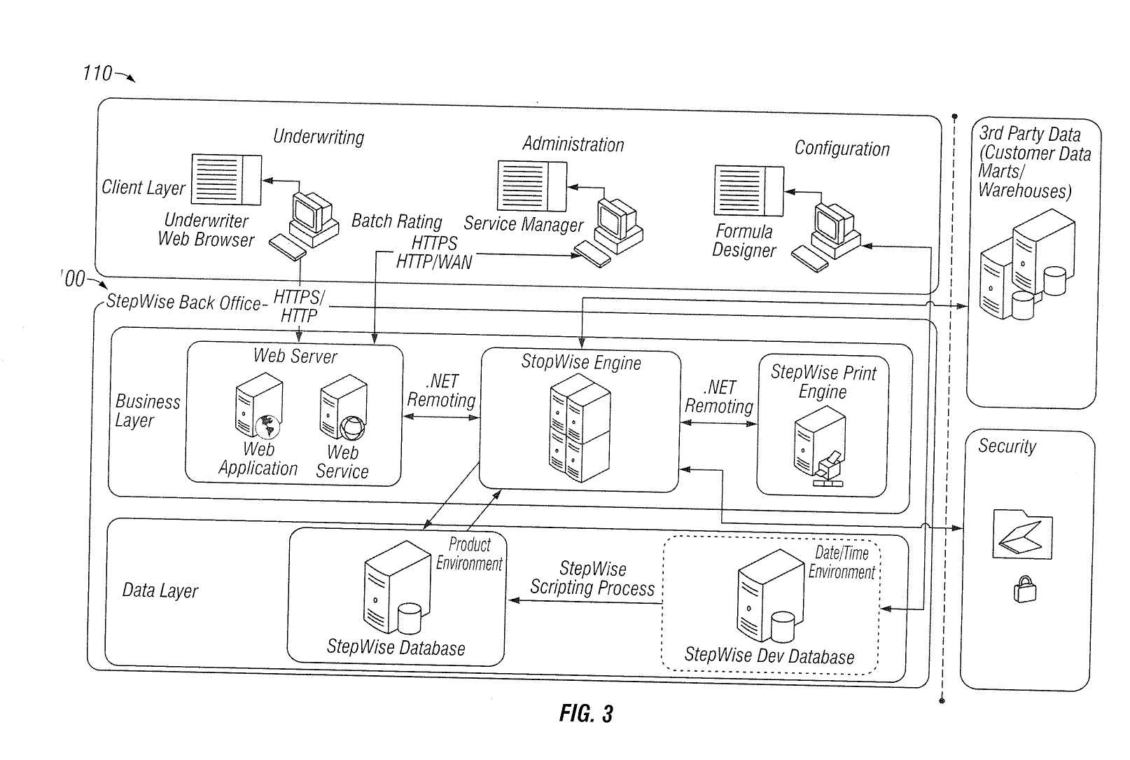

Referring now to the exemplary embodiment shown in FIG. 3, the interaction between each server component in a single-server installation is shown. Calls between components of automated rating engine 100 and other components, such as those of interface 110, may be made using either .NET Remoting or SOAP/Web Service Calls.

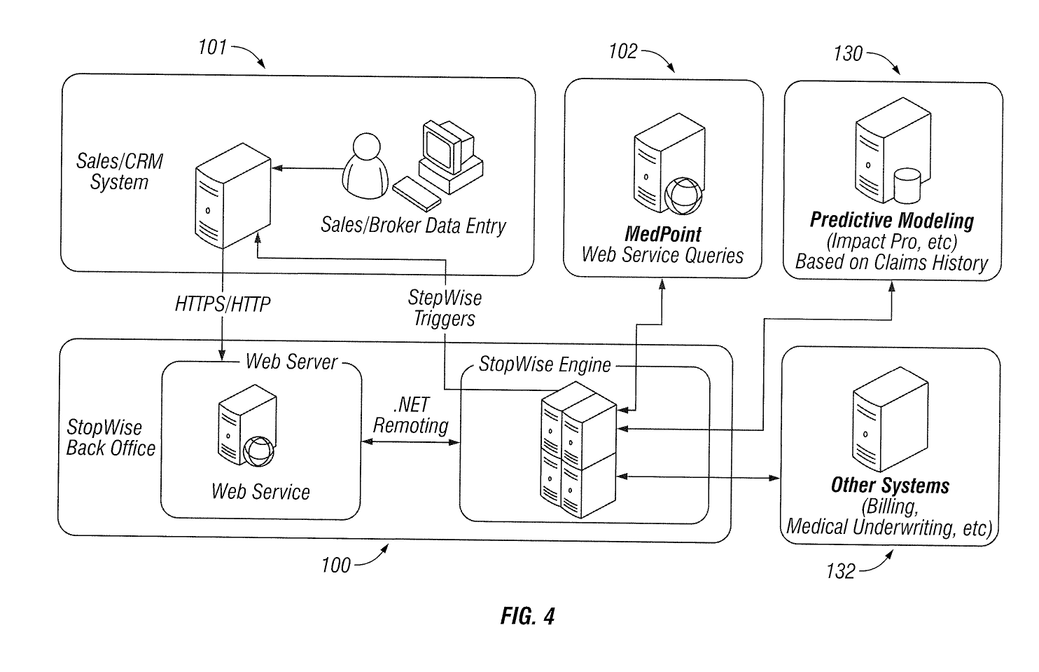

As shown in the exemplary embodiment of FIG. 4, automated rating engine 100 may be deployed in an integrated environment with a sales/CRM system 101, a web service query 102 (for example, MedPoint), a predictive modeling tool 130, and other systems 132.

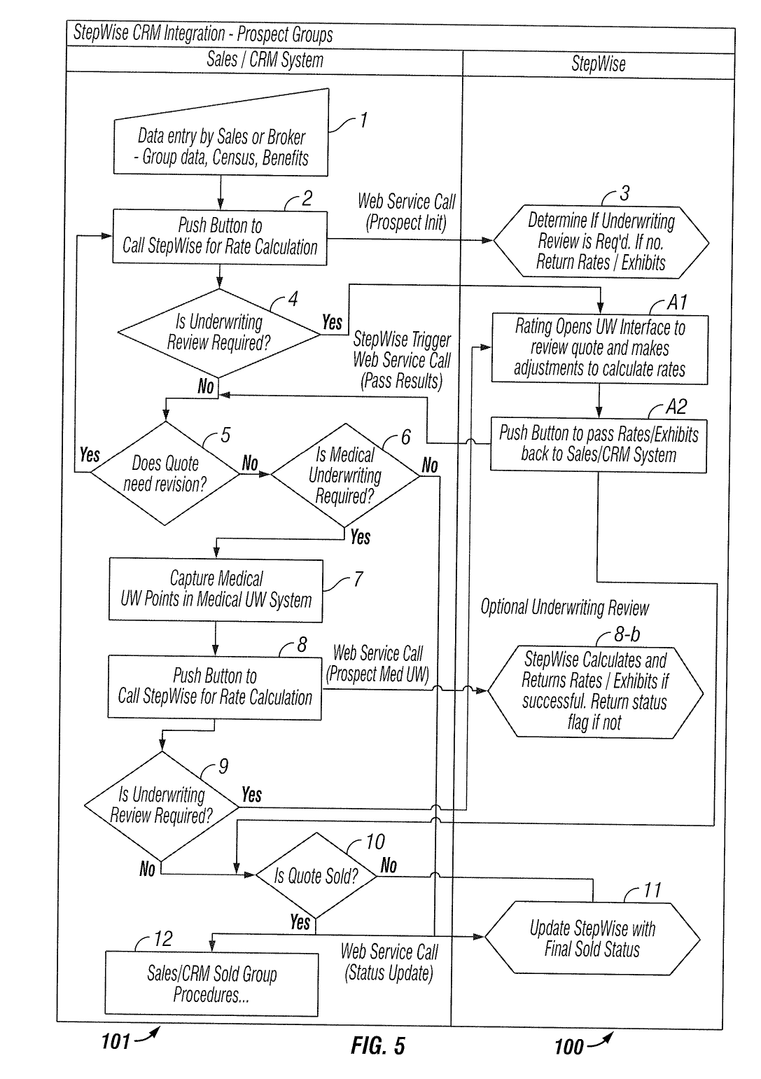

Referring now to FIG. 5, an exemplary embodiment illustrates one manner in which automated rating engine 100 might be integrated with a sales/CRM system 101. Communication between CRM system 101 and automated rating engine 100 may be handled by passing XML documents to web services running separately on each system.

Server components of automated rating engine 100 may include various Windows services such as the automated rating engine's Calculation Engine and the automated rating engine's Print Service—as well as the automated rating engine's Web Service. The automated rating engine Web Service can be a simple ASP.NET application written in Visual Basic.NET that serves as the interface between the Engine and Print Service and other applications including the automated rating engine's client. In one exemplary embodiment, the automated rating engine's Web Service simply receives method calls and forwards them to either the Engine or Print Service using .NET Remoting.

The Web Service of automated rating engine 100 may include a series of methods that fall into two categories:
1. Session Based Methods. These calls are differentiated by the fact that automated rating engine 100 keeps each quote open between a series of calls into automated rating engine 100. An example of a session for a quote might consist of a series of method calls as follows:

OpenQuote or NewQuote—creates a new quote or opens an existing quote.

ChangeValue—validates and changes the value for a given step. This call can be repeated for as many values as desired to pass into automated rating engine 100. After each ChangeValue call, automated rating engine 100 may re-calculate all values in the quote.

GetStepValue—gets the value of a given step. This call can be repeated for as many values as you wish to pull from the automated rating engine.

SaveQuote—saves results to the quote database of automated rating engine 100.

CloseQuote—closes the quote on the server.
2. Single Call Methods. In this embodiment, an entire transaction can performed in a single web-service call. Automated rating engine 100 may create or open a quote, pass a series of values from an XML document into automated rating engine 100, save and close the quote, then return an XML document with selected values from the quote. Because automated rating engine 100 does not re-calculate between each value that is changed, these method calls can be faster than a series of session based calls.

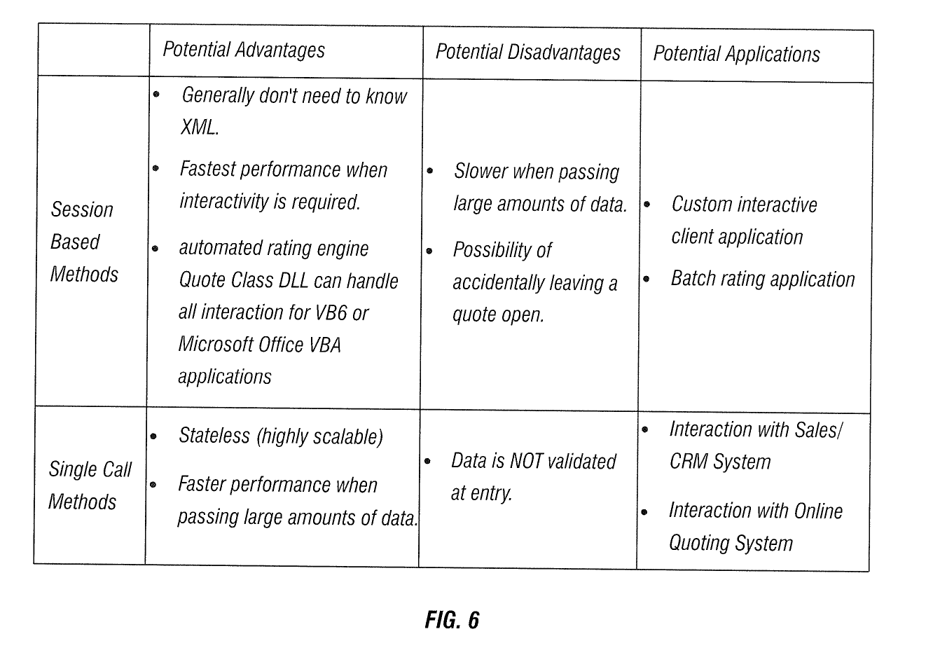

FIG. 6 shows the differences between sessions based methods and single call methods, along with a list of situations where each set of methods may be applied.

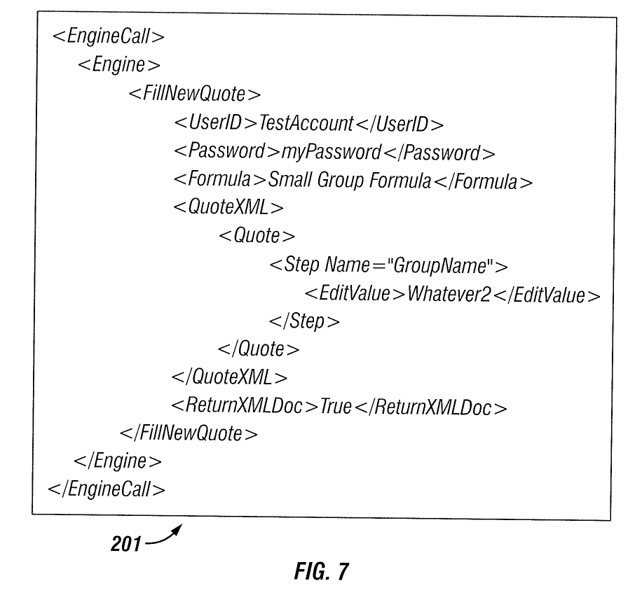

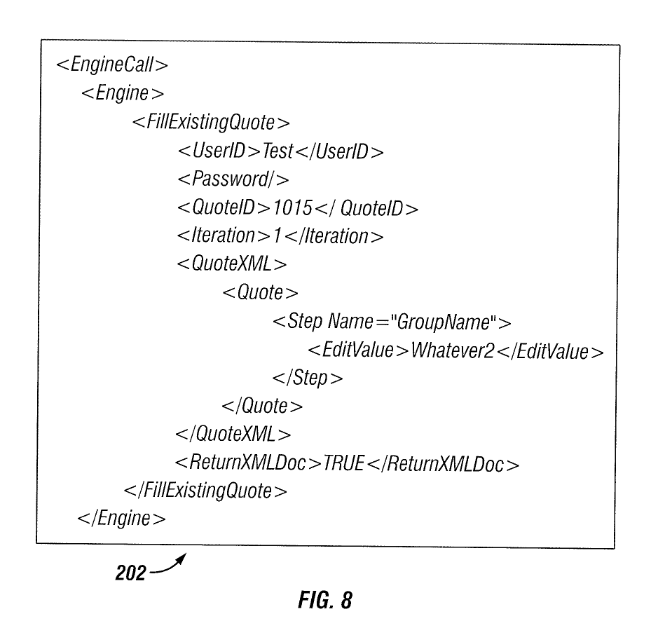

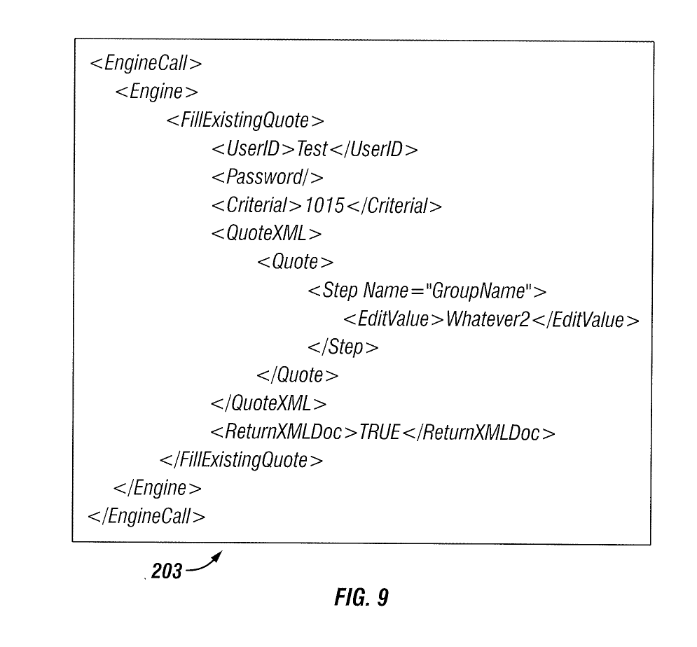

Source code may be used to create and edit quotes. Referring to FIG. 7, one embodiment of source code 201 may be used to create a new quote. As shown in FIG. 8, one embodiment of source code 202 may be used to update an existing quote. FIG. 9 illustrates one embodiment of source code 203 in which criteria nodes can be used to pass criteria to a stored procedure that finds the quote.

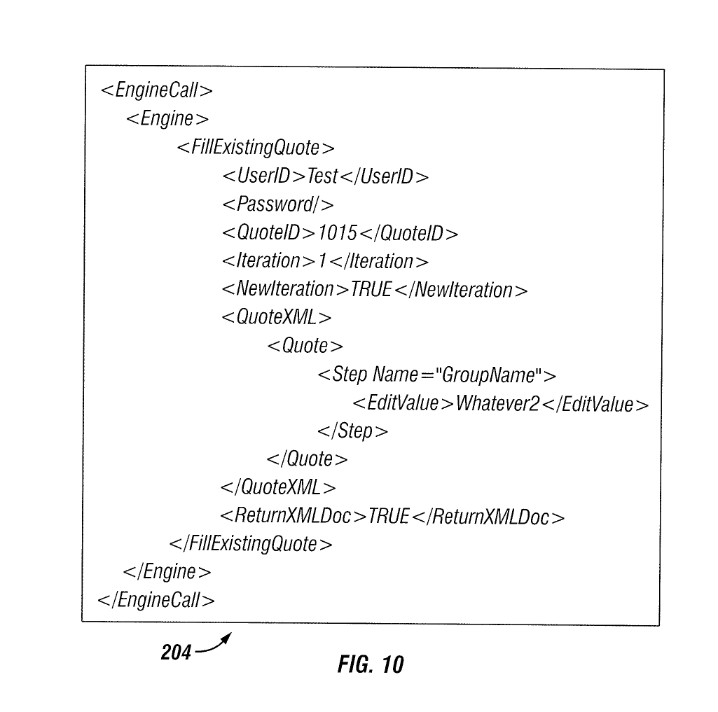

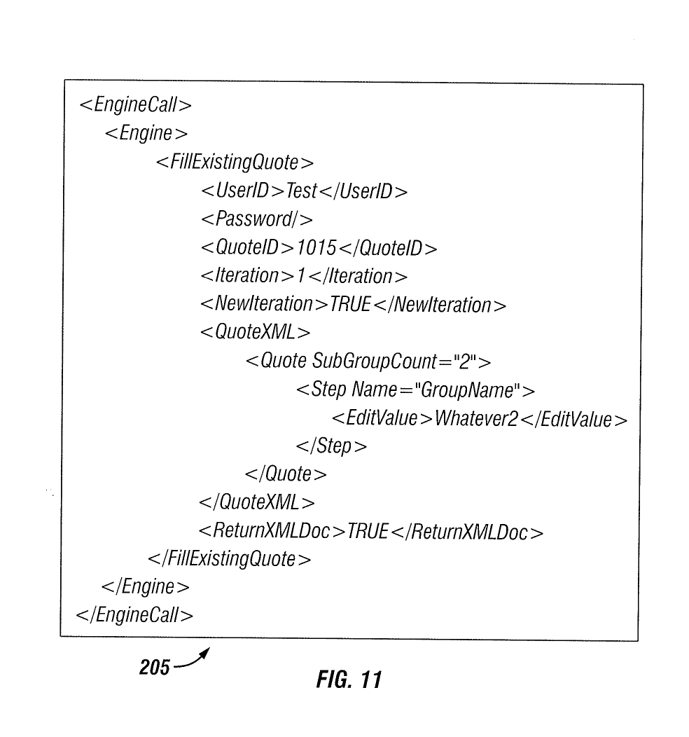

Referring now to FIG. 10, one embodiment of source code 204 may be used to create a new quote iteration which is a copy of the quoteID and Iteration specified in the xml. New steps passed into the call can be used to update the new quote, and the new iteration can be returned in the return xml. As shown in the embodiment of FIG. 11, inbound integration calls into the automated rating engine can allow applications to update the number of subgroups.

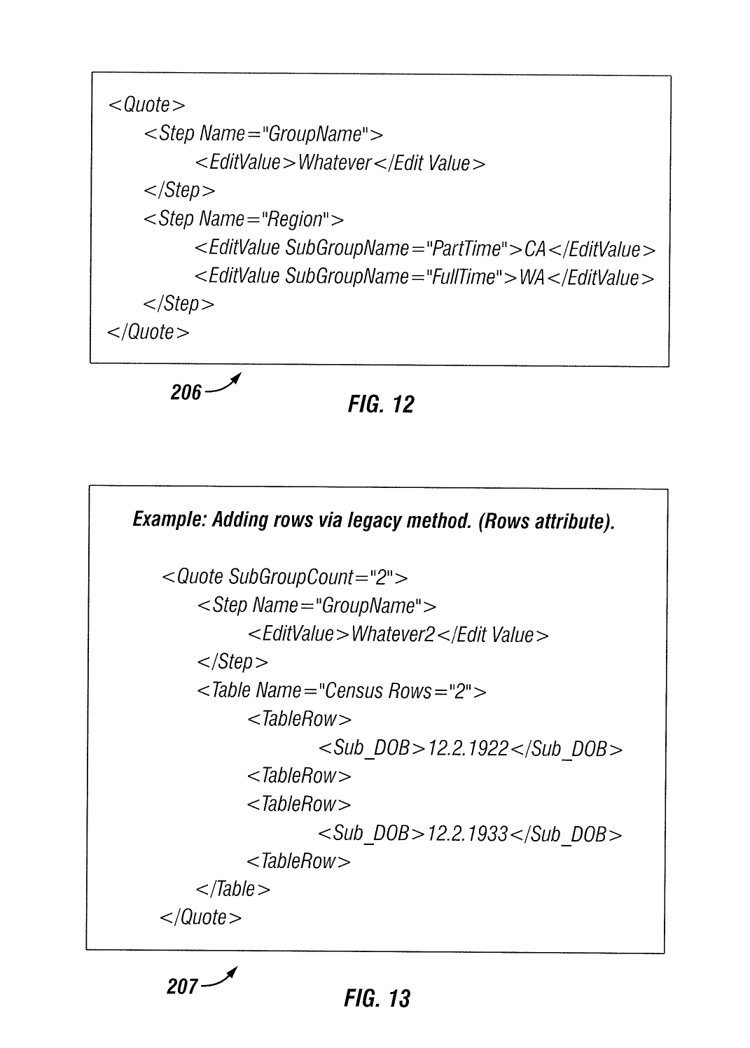

Referring now to FIGS. 12-15, source code 206-209 can be used to update step values, update or add table data (adding rows via the legacy method or new table actions), and update table row contents.

### Formulas

A formula in automated rating engine 100 may represent a single rating methodology. A typical plan may start out with four separate formulas: (1) Large Group Prospect; (2) Large Group Renewal; (3) Small Group Prospect; and (4) Small Group Renewal.

Additionally, a plan may have special formulas such as one for association business or one that is used for “ancillary” purposes (e.g., a tool that is solely used to calculate benefit relativity differentials).

### Steps

A formula can be created as a series of “Steps”. Each step may represents a single piece (or an array) of information that is used to build up final rates within a quote. Examples of a step include underwriter input, a lookup on a factor table, or a calculation. A step may be as analogous to a cell in a spreadsheet. Each step may include a set of attributes that are assigned to it which identify, among other things, what formula may be used to calculate the results for the step. [e.g., TotalTrend=(1+TrendFactor)̂(TrendMonths/12)].

Each step may include a set of attributes that are assigned to it which identify the format shown on screen, e.g., number of decimal places. A step may include a set of attributes that are assigned to it which identify whether the calculated value can be overwritten by the user, and if so, what permission level may be required by the user to overwrite. Step attributes may also identify information from an outside data source such as census that may be used to automatically populate the step when automating data for renewals.

### Factor Tables

A factor table may be used behind the scenes to lookup a value for a step. In certain embodiments, it can be used to lookup a single value based on up to seven dependencies. For example, a plan might vary its base rates by (1) Region, (2) Provider Network, (3) Group Size, (4) Deductible, (5) Coinsurance, (6) Out of Pocket Maximum and (7) Office Visit Copayment.

A factor table may be date specific—that is—factors may vary over time. Factors may vary both based on the effective date of the group and a separate version date called the Quote Date (this is usually defaulted to the date the quote was created). When a factor table changes, the effective date and quote dates can be used to determine which factors to use. In exemplary embodiments, if a quote is created before the change is implemented (before the Quote Date of the new factors), and the quote is opened after the change, the old factors will still be used. If it is desirable to change the quote to use the new factors, it is possible to override the Quote Date of the quote.

The automated rating engine's Factor Tables may be used to lookup values that may be used within the automated rating engine formulas. Unlike data tables, the factor tables may not show up in the automated rating engine interface. The automated rating engine may have an unlimited number of factor tables. Note that factor tables may not be formula specific. Any or all formulas may be able to perform lookups on any given factor table.

Factors in a factor table may be looked up based on an identified number of pieces of information. In one exemplary embodiment, the age/sex factor is looked up based on (1) Tier, (2) Gender, (3) Age Band, and (4) Group Size.

Data Tables
A data table may be thought of as analogous to a table in a database such as Microsoft Access. It can be used to capture information that is generally stored as rows and columns. There may be two types of tables. One type of table allows for inserting and deleting rows. These tables may effectively have an unlimited number of rows. Such a table may be used to enter information that may be dynamically sized, for example, large claims. Another type of table allows you to enter data within a fixed structure. Such a table may be used for summarized census information.

Quotes
A quote is a set of input data and calculated data for a single group. A quote may be linked to the automated rating engine's Formula module which may be used to calculate rates and other results for the quote. A single quote may calculate the rates for multiple subgroups within the group.

In one embodiment, a plan might have a single quote for each group for each renewal year. In other embodiments, however, the automated rating engine may create multiple quotes for a single group to represent different rating or benefit scenarios. Each quote in automated rating engine may have a unique ID which is formatted as, for example, NNNNNNN-NN. The first seven digits can be the Quote ID for the entire quote and the last two digits can be the Iteration ID. In certain embodiments, each new quote starts with a system-generated Quote ID and an Iteration ID of 01.

Iterations
In certain embodiments, an iteration is a version of a quote. Iterations may be used primarily to organize multiple quotes created for a single group. However, there may be no direct linkage between iterations of a quote.

In certain embodiments, an iteration may be created as a copy of an existing quote iteration. When the iteration is created, all of the data may be copied from the original iteration, but no links may be created. Thus, changes to one iteration of a quote may not impact other iterations.

Each iteration of a quote may have the same Quote ID but a different Iteration ID (with 01 being the original iteration).

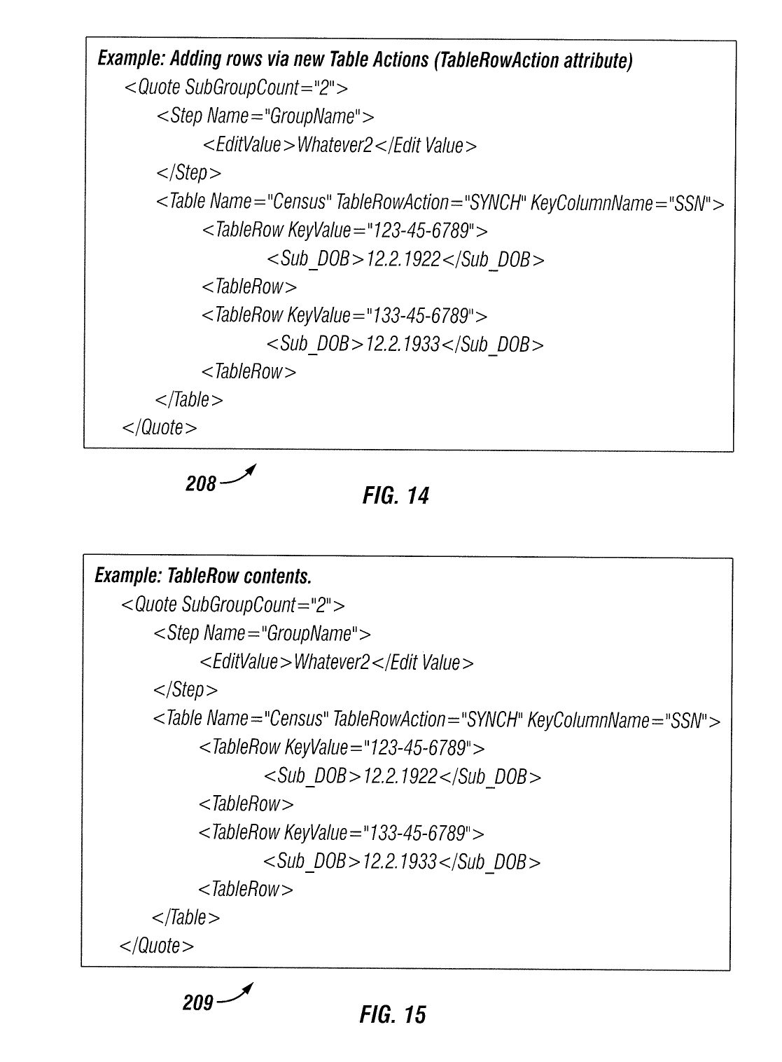

Referring now to FIG. 16, a quote summary 210 allows the user to see values from selected steps for all subgroups and categories. It may provide a configurable summary of the quote, and may show steps that are important to the quote.

Predictive Modeling Tool

One of the strengths of predictive modeling tool 130 is its ability to predict health risk for a member population. The predictive modeling tool 130 may be able to provide predictive modeling for individuals and groups. Using information readily available from medical and pharmacy claims, laboratory results, as well as member enrollment files, predictive modeling tool 130 can use a variety of risk models to predict which patients are at greatest risk for severe healthcare problems in the future. These risk models may be developed using historical information drawn from a population of more than 35 million lives. In some embodiments, predictive modeling allows for the identification of members at risk for severe health problems before they experience those problems.

The value of predictive modeling tool 130 may be driven by medical and care management experts who can identify factors that predict future risk and gaps in care, and can translate market requirements into easy-to-use software solutions. The value of predictive modeling tool 130 may also be driven by the IHCIS National Managed Care Database, a large database that includes the complete medical history for more than 35 million lives.

Working with the healthcare experience of large populations, IHCIS experts can quantify the risk related to a condition and the degree of risk added by significant medical care events, co-morbidities, and complications. This testing allows the predictive modeling tool 130 to more accurately predict future risks, including, for example, potential customers seeking insurance benefits.

The predictive modeling 130 tool can provide actuaries and insurance companies, and underwriters with the health risk information they need to set appropriate rates for premiums. Like care managers who use the predictive modeling tool 130 to leverage historical information about members' past care in order to predict future healthcare problems, actuaries, and underwriters may use the predictive modeling tool's risk models to generate measures of future health risk and the potential costs associated with those risks. In addition, actuaries and underwriters may have specialized risk information needs that the predictive modeling tool addresses.

Aggregate Reporting

While care managers use risk data at the individual member level on a day-to-day basis, actuaries and underwriters may typically perform risk analysis for groups of individuals, so they can set the appropriate premiums for populations or groups. The predictive modeling tool may provide aggregate reports that describe risk for specified groups of members.

Risk Analysis for New Groups

Actuaries and underwriters may also use slightly different criteria for performing their risk analysis. When evaluating the risk for a new group, actuaries and underwriters may sometimes base their calculations on a limited set of demographic information, such as the age and gender of each group member, because medical and/or pharmacy information is not yet available. In other situations, actuaries and underwriters can base their analysis on the group's detailed medical and/or pharmacy claims, along with demographic information. The predictive modeling tool 130 may offer different risk markers for actuaries/underwriters that use demographic data alone or pharmacy data alone, to supplement other risk models based on medical and pharmacy claims.

Gap-based Risk Analysis for Renewals

Actuaries and underwriters may have specialized timing requirements for performing their risk analysis. For example, a care management program may need predictions of population risk for the next 12 months based on historical information from the past 12 months. In contrast, an underwriter may need to predict health risk for a future period after a premium takes effect. To accommodate the difference in timing between data availability and renewals, the predictive modeling tool 130 may offer a specialized A/U risk model for actuaries/underwriters that determine risk for a 12-month period that occurs 6 months in the future.

### Example

In one exemplary situation, an underwriter begins in June to work on the renewals for the start of next year, 6 months in the future. Using the Aggregate Reports of predictive modeling tool 130, the underwriter notices that the first two employer groups in his renewal list have been with the managed care organization for the last year, are approximately the same size (about 150 employees) and are in the software industry (Prepackaged Software). It is also noted that the group risk scores based on the predictive modeling tool's specialized risk model for actuaries/underwriters are significantly different.

The first group has a group risk score of 1.4, a little higher than normal, but perhaps not alarming. The second group, however, has a score of 2.7. Using the predictive modeling tool 130, the underwriter drills down into the source of the risk for the second account and discovers that there are a number of recently diagnosed chronic disease patients who are driving much of the risk for that employer group. Armed with this information, the underwriter may then export the predictive modeling tool 130 information to his Excel Renewal Worksheet. He may then load the rate for this account with the appropriate Industry-specific loads, risk load, and other complementary loaded rates. Lastly, he can send a note to Care Management that there is an opportunity to offer chronic disease care management services to the second account.

### System Components

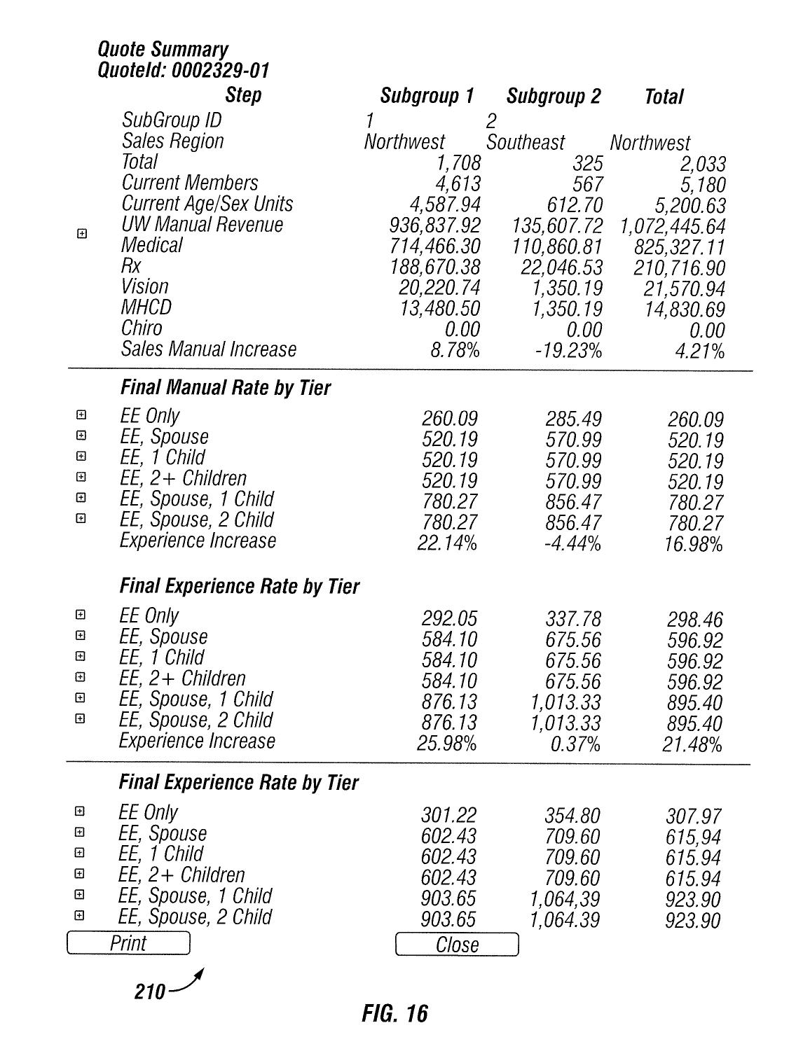

As shown in FIG. 17, the predictive modeling tool 130 may include three basic components: a predictive modeling tool Processing Engine 131, a predictive modeling tool Datamart 132, and a predictive modeling tool Reporting System 133.

In certain exemplary embodiments, predictive modeling tool Processing Engine 131 is a Windows server/workstation-based application that transforms data inputs, including member and claims information in the form of the MEMBER Table and the SERVICE Table, into key outputs, and produces a dataset that resides within the predictive modeling tool Datamart. The Processing Engine may include the following functions: (1) Calculate risk measures of members; (2) Determine whether members exhibit gaps in care that are responsive to care management intervention; (3) Evaluate clinical factors for members, based on their care history and an organization's objectives, and mark members as candidates for the appropriate care management programs; and (4) Create aggregate information for groups of members, for reporting purposes.

The predictive modeling tool Datamart 132 may include a collection of datasets and map tables used for reporting. Each dataset may include a set of tables output by the Processing Engine 131 that represents data processed for a specific period. Datasets processed by the Processing Engine 131 to the predictive modeling tool Datamart 132 on a periodic basis may be added.

For example, the Processing Engine 131 generates Dataset 1 using member information for the 12-month period ending January, 2005. The following month, it generates Dataset 2 for the period ending February, 2005. Each dataset may provide a snapshot of the currently enrolled member population, along with their most recent 12 months of care history. Each reflects a different set of members, as members enroll in and terminate coverage, and a different set of claims information, as recent datasets include more recent medical and pharmacy claims.

When the predictive modeling tool system is implemented, the Datamart 132 may include sets of map tables that describe procedure codes, drug codes, and so on, and a demonstration, or sample, dataset of member profiles that you can view in the Reporting System 133.

There are several ways to view the data in the predictive modeling tool Datamart 132, including: (1) using the predictive modeling tool Reporting System 133; (2) using the tools chosen by the user to query the Datamart 132 and manipulate the data; and/or (3) importing the data into other applications. For example, a user can import data into an organization's case management system.

Predictive modeling tool Reporting System 133 may be a Windows server-based application used to display data from the predictive modeling tool Datamart 132 through a Web browser. The system may be deployed through the Internet or through a corporation's intranet.

The Reporting System 133 may provide standard reports, and may allow for the creation of custom reports describing certain member population or sub-populations. It may also provide detailed reports that describe members' markers of risk and prior utilization. These reports provide significant value and facilitate data analysis by clinical, administrative, and financial staff.

Depending on the information available, the requirements of the insurance company, and the predictive modeling tool module, some or all of the data input sources described in this section may be used.

### Types of Inputs

Below is an exemplary list of inputs. One of ordinary skill in the art can recognize other suitable inputs may be used, including, for example, credit history, employment data, and the like.

Member Enrollment Data may be used as an input in an exemplary embodiment. Information about a member, such as a member identifier, date of birth, and gender.

Medical Claims Data may be used as an input in an exemplary embodiment. Information about a member's claims history, such as date of service, procedure code, primary/secondary diagnosis codes, admission date, and provider ID. In one exemplary embodiment, the system uses the past 12 months of claims history as input for processing, although other time periods can be used. Alternatively, custom service-related information may be imported into the system.

Pharmacy Claims Data may be used as an input in an exemplary embodiment. The system may use the past 12 months of claims history as input for processing, although other suitable time periods can be implemented.

Lab Test Results may be used as an input in an exemplary embodiment. Clinical detail about the member's past 6 months of lab tests and test results, or other suitable time periods, can be implemented.

The identity of providers may be used as an input in an exemplary embodiment. A list of providers that includes provider ID and primary care indicator. Custom provider-related information may be imported into the system, such as provider name and specialty.

Health Risk Assessment (HRA) Survey Information may be used as an input in an exemplary embodiment, including the member's responses to health risk assessment survey questions. For example, an HRA survey about the member's health may be used. This survey may be conducted by a case manager or completed by the member.

Pro Active Module Definition Table Data may be used as an input in an exemplary embodiment. The input tables used for the Pro Active modules, sometimes known as definition tables, may define sets of criteria for each clinical indicator, care opportunity, case definition, and care alert component.

Member Profiles

The predictive modeling tool Reporting System 132 may provide Member Profiles for viewing key information for an individual member, and provides Group Profiles for viewing key information for a specified group of members.

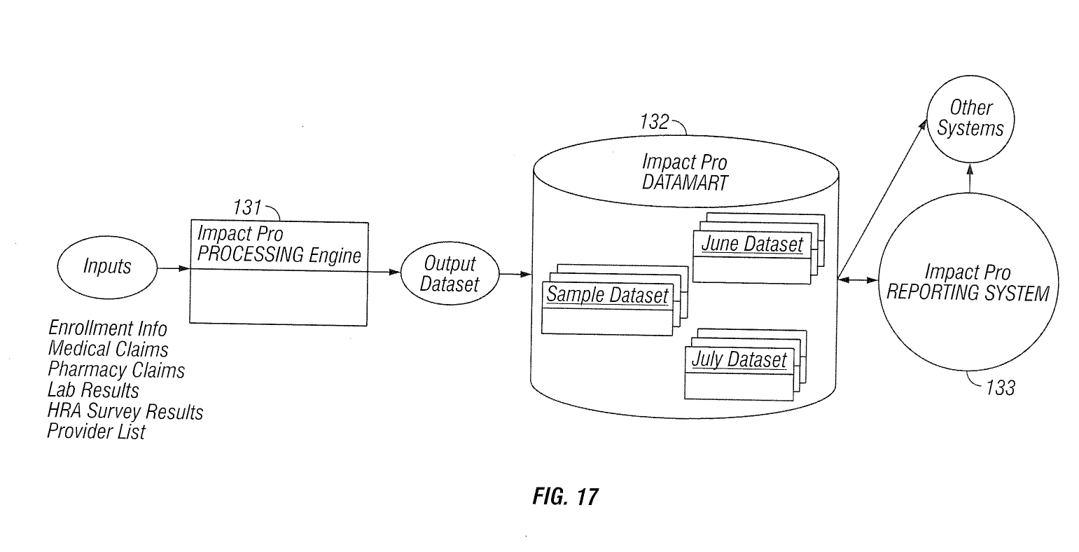

In one exemplary embodiment, the system can display such information in the form of a Member Profile 211, shown in FIG. 18. The Member Profile may contain three general categories of information about each member, including, without limitation: Care History Profile, Risk Profile, and Pro Active Clinical Profile.

In exemplary embodiments, the Care History Profile may contain information about the member's healthcare history, such as past medical and pharmacy claims, inpatient stays, healthcare episodes, and utilization information. In exemplary embodiments, the Risk Profile may include information about the member's future healthcare risk, potential future costs, and the factors that contribute to that at risk. In exemplary embodiments the Pro Active Clinical Profile may include information that identifies key clinical issues, such as the case definitions for which the member qualifies, indicators of the member's current clinical state, immediate intervention opportunities for improving health outcomes and reducing costs, and key information required for member assessments.

In other exemplary embodiments, a Member Group Profile 212 may be displayed, similar to that shown in FIG. 19.

Care History Information

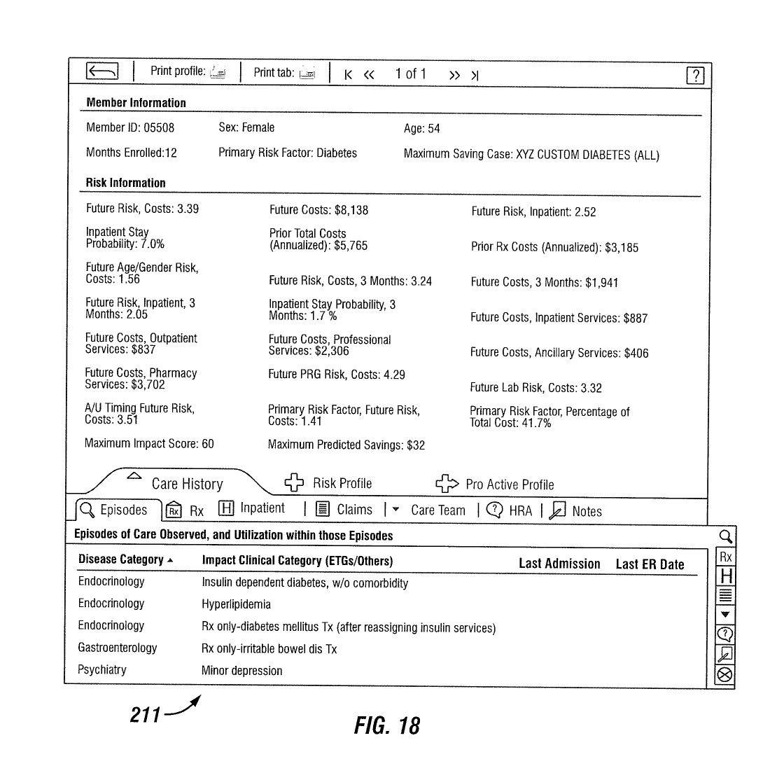

This section describes the major processing activities that the predictive modeling tool 130 performs to process care history information for a member population. A flowchart 213 outlines these tasks as shown in FIG. 20.

One step in flowchart 213 is to input data elements such as member enrollment records, claims data from your organization, and lab test results. After the data elements have been inputted, the system may compile clinical information per member. The system may array the input data by member, grouping together the entire member's clinical information. Next, the system may identify inpatient admissions and Rx claims. Using the member's claims history, the system may identify confinements and pharmacy claims.

The system may also calculate lab test trends. For each lab test result input, the system may calculate the result's relation to a “normal” result, and determine how the result relates to past test results for the member. The system may also assign a provider care team. The system may identify the key provider care team members associated with each member, based on the services those providers delivered to the member. In certain embodiments, the system may assign HRA Results. The system may identify the health risk assessment (HRA) survey result information associated with each member. As an output, the system may provide a member profile care history. The system may assemble the care history information that describes the member as part of the dataset. In the Reporting System, this information may be viewed as part of a Member Profile and use it for analysis and reporting.

Processing Care History Information

The following describes the processing activities that the Processing Engine 131 may perform to provide the Reporting System 132 with care history information from the member population. In one respect, the system may process certain healthcare data on a “pass-through” basis, simply compiling that information by member for viewing, selection, and/or reporting. In another respect, the system may create certain healthcare information that summarizes or interprets raw clinical data, for ease of use by care management staff, and faster identification of members on key criteria during the viewing, stratifying, or reporting on members.

Processing Member Enrollment Information

In certain exemplary embodiments, the system may process member enrollment data on a “pass-through” basis, that is, it does not transform the data, but organizes the data by member so the data may be used for viewing, selection, and/or reporting. Certain member information may be required such that additional custom member information values may be imported into the system to track other member-related data, such as account, region, credit history, and the like.

The system may use the member's enrollment information and demographic data extensively. In one respect, the system may the data to predict risk on demographic measures such as age and gender, and a user can use enrollment data to identify members for specific types programs or follow-up action according to the user's organization's criteria.

Processing Health Risk Assessment (HRA) Information

In one embodiment, the system may process member HRA responses on a “pass-through” basis, that is, it does not transform the data, but may organize the responses to survey questions by members for viewing, selection, and/or reporting.

Processing Medical Claims Information

In one embodiment, the system may process the member's claim history on a “pass-through” basis that is, organizing the data by member for viewing, selection, and/or reporting. This claims history may include both medical claims and pharmacy claims. The system may use this data for predicting future risk and for identifying the member's past conditions in order to determine a future course of action.

Identifying Inpatient Admissions

In one embodiment, the system may use data from the member's claims history, the system may identify each of the member's inpatient admissions over a time period, such as a 12-month experience period.

Identifying Pharmacy Claims

In one embodiment, the system may use data from the member's claims history, the system may identify each of the member's pharmacy, or prescription drug, claims over a time period, such as a 12-month experience period and classifies those claims as a pharmacy claim. This may allow users to view or report on pharmacy claims as a subset of all claims.

Identifying Provider Teams

In one embodiment, each claim provided into the predictive modeling tool may include a provider ID. During processing, the system may use this information to identify the key providers associated with a given member's care. This team includes the member's primary care provider (PCP) and a group of providers associated with selected conditions such as: (1) Primary care; (2) Cancer; (3) Cardiovascular, excluding hypertension; (4) Diabetes; (5) Asthma/COPD; (6) Hypertension.

During processing, the system may identify the primary provider based on the provider who supplied the greatest number of primary-care related services. For the other provider team members, the system may identify the team member who provided the greatest number of disease-related services, using episode clusters to count services.

Processing Lab Tests

The system may include information lab tests performed for members and the results of those tests over a certain time period or over the entire medical history of a member. In addition, the Processing Engine 131 may classify the lab test result relative to the typical normal range for the test and indicate any significant change in the results, as compared to previous results for that lab test.

Categorizing Test Results

The system may categorize each lab test result using a comparison to a normal range of results. It may assign each finding with, for example, an eight value range as follows:

1—Extreme Low Value

2—Low Value

3—Normal Value

4—High Value

5—Extreme High Value

6—Positive

7—Negative

8—Other

It may base these assignments on the test result and thresholds established around the normal range of values for the test. For some lab tests, these thresholds vary depending on a patient's age and gender. For lab tests reported using a character field, such as “positive,” it assigns test findings to one of three values, positive, negative, or other.

Identifying Test Trends

Members may have multiple occurrences and results for the same lab test. In this instance, the relative change in findings over time may provide useful information for understanding member risk. For patients with multiple results for the same lab test on different days, the system may compare the earliest and most recent results to determine whether a significant change in the level of the finding has occurred.

Where multiple tests are available, the system may classify the trend in results as a significant increase, a significant decrease, or no significant change. An example of a significant change is a patient with an earlier test result classified in the Normal Value range for that test and a more recent finding that falls within the Extreme Value range.

About Member Notes

Care managers may enter and view notes about individual members in the predictive modeling tool Reporting System 132. In certain embodiments, these notes may originate in the Reporting System and do not receive any processing within the Processing Engine.

Measuring Health Risks

In one embodiment, this section describes the processing activities that the predictive modeling tool 130 performs to process health risk-related information for a member population.

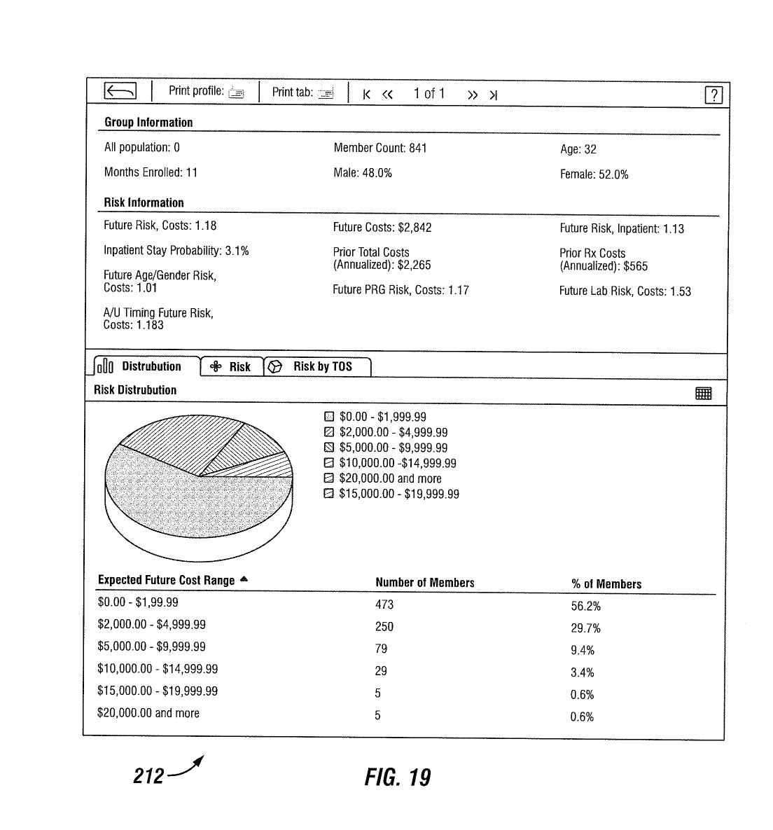

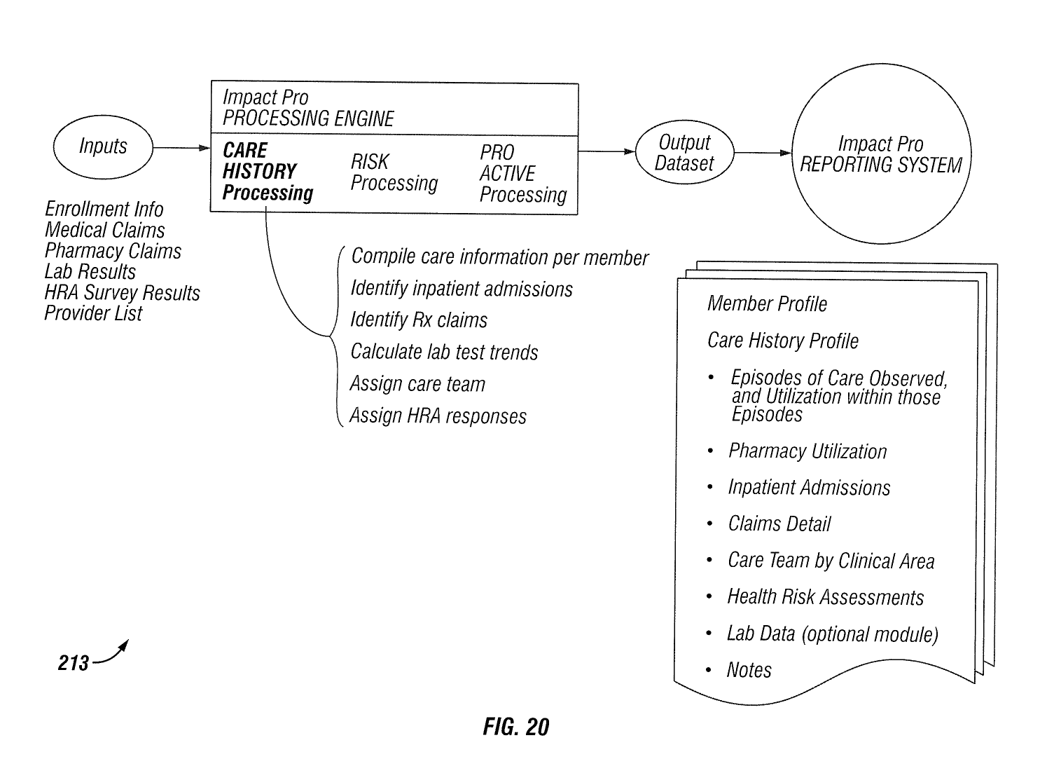

Flowchart 214 shown in FIG. 21 illustrates one embodiment of high level risk processing, while flowchart 215 in FIG. 22 illustrates an embodiment of a more detailed level risk processing.

The steps of flowchart 214 are discussed below. It is understood that these steps are only one exemplary embodiment, and other exemplary embodiments may comprise variations on the functions described herein.

Data Inputs used for Measuring Risk

The data inputs for processing risk may vary depending on the type of risk methodology(s) needed to use and the type of risk scores that the Processing Engine generates. The Standard risk model may use enrollment information, medical claims, and pharmacy claims.

Group ICCs

The system may group claims into unique episodes of care and other diagnosis-based Impact Clinical Categories (ICCs). These categories may describe a member's observed mix of diseases and conditions and underlying co-morbidities and complications.

Assign Risk Markers

The system may assign two types of risk markers to each member: base markers and service-based risk markers. The ICCs for each member may be further grouped into homogeneous risk categories, called base markers. Hierarchies and other algorithms may be applied to optimize this grouping. Demographic markers of risk are also created during this step—describing a member's age and gender.

The medical services observed within the context of a clinical condition and other utilization events may be used to create service-based markers of risk. These markers may be derived from a patient's higher acuity events (inpatient and ER), significant contacts with a physician (episode service clusters), and use of pharmacy services. The timing of a service may also be a factor in assigning these markers. The system may compile a set of risk markers included in the Standard risk model for each member. It may assign all members an age-sex marker. In addition, members may have zero, one, or more base markers or service-based markers. Members without claims may have a marker for their age-gender category.

Weight Markers and Calculate Member Risk

The system may apply weights describing the contribution of each marker to overall patient risk. The weights may differ depending on the outcome being predicted (for example, cost versus inpatient utilization) as well as the data available for deriving predictions (for example, medical and pharmacy claims versus medical claims only). The system may combine the member's array of markers and the weights associated with those markers to compute member risk for each outcome.

Output: Member Risk Profile

The system may assemble the member's risk measures and other relevant information describing the member and the member's mix of risk factors to support the predictive modeling tool Datamarts, reports, and reporting application.

Types of Risk Models

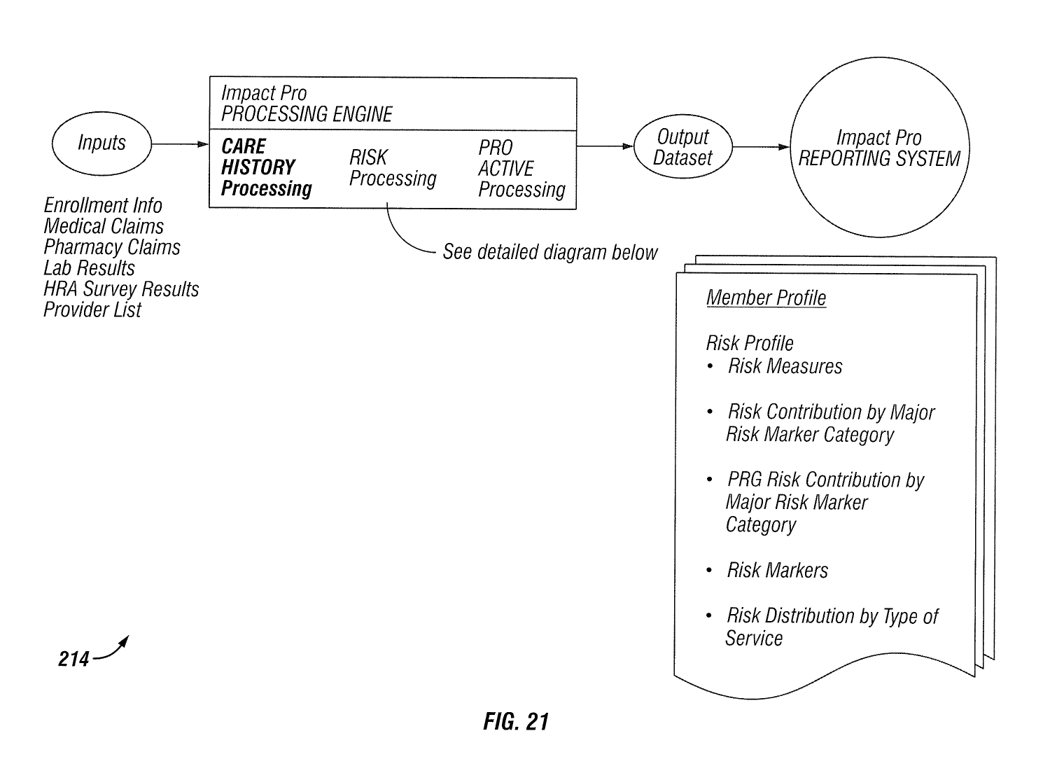

FIG. 23 describes the some of the risk models available to the predictive modeling tool and compares them on several key criteria. The appropriate timing for a risk model can depend upon the application. Understanding these time periods may determine which risk methodologies and risk scores are best suited for the application. The “timing” for a risk model can have three components, each described in months. The first, the Experience Period, is the time period used to capture the prior claims history used in assigning risk to a member. The second, the Gap Period, is the number of months, if any, assumed to exist between the experience and prediction periods. The third, the Prediction Period, is the number of months that the model is predicting.

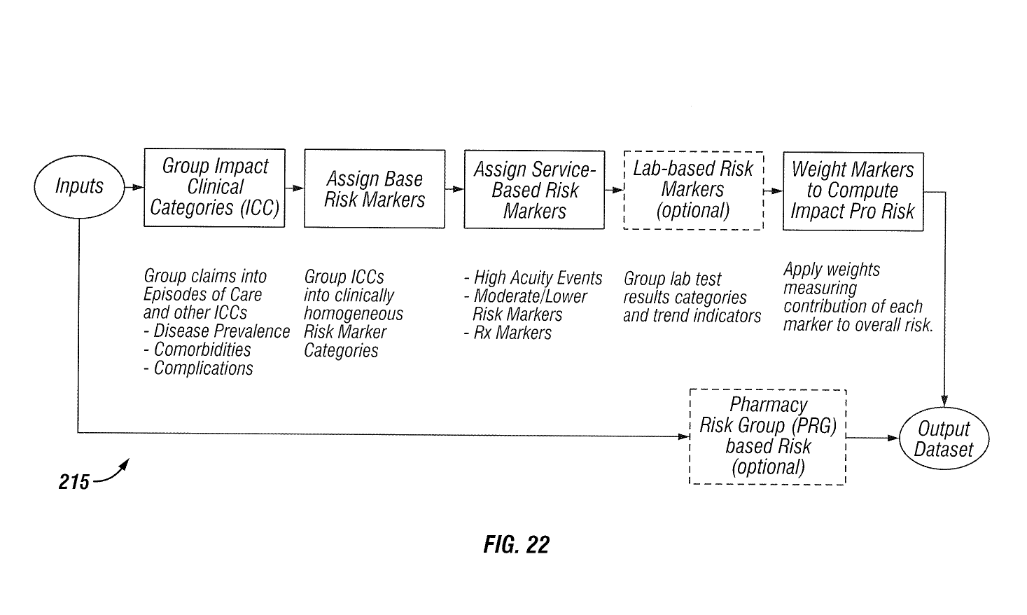

For example, the Standard risk model timing is 12-0-12, representing an experience period of 12 months, a gap of 0 months, and a prediction period of 12 months. The predictive modeling tool uses the past 12 months of historical information about health plan members as the experience period. It may estimate future risk for a 12-month prediction period for generating risk outputs. As the Standard risk model timeline diagram in FIG. 24 illustrates, there is no gap in time between the experience period and the prediction period. FIG. 24 shows an experience period is the 12-month period ending in May, 2005, and the prediction period is the 12-month period beginning for June, 2005. The processing date shown in FIG. 24 falls on June 24th, because this hypothetical organization processes its data several days after each month-end. The processing date does not affect the risk calculations, although the sooner the data is processed, the sooner the information is available.

Impact Clinical Categories and Episodes of Care

The predictive modeling tool may use the standard episodes of care and other clinical categorizations to describe a member's conditions and diseases and the services involved in their diagnosis, management and treatment. These episodes and other groupings used by the predictive modeling tool are called Impact Clinical Categories (ICCs).

A member's episodes of care may describe a member's mix of clinical conditions, the severity of those conditions, and the member's overall level of risk. The predictive modeling tool can use patient episodes as a context for creating markers of risk.

Episode Treatment Groups (ETGs)

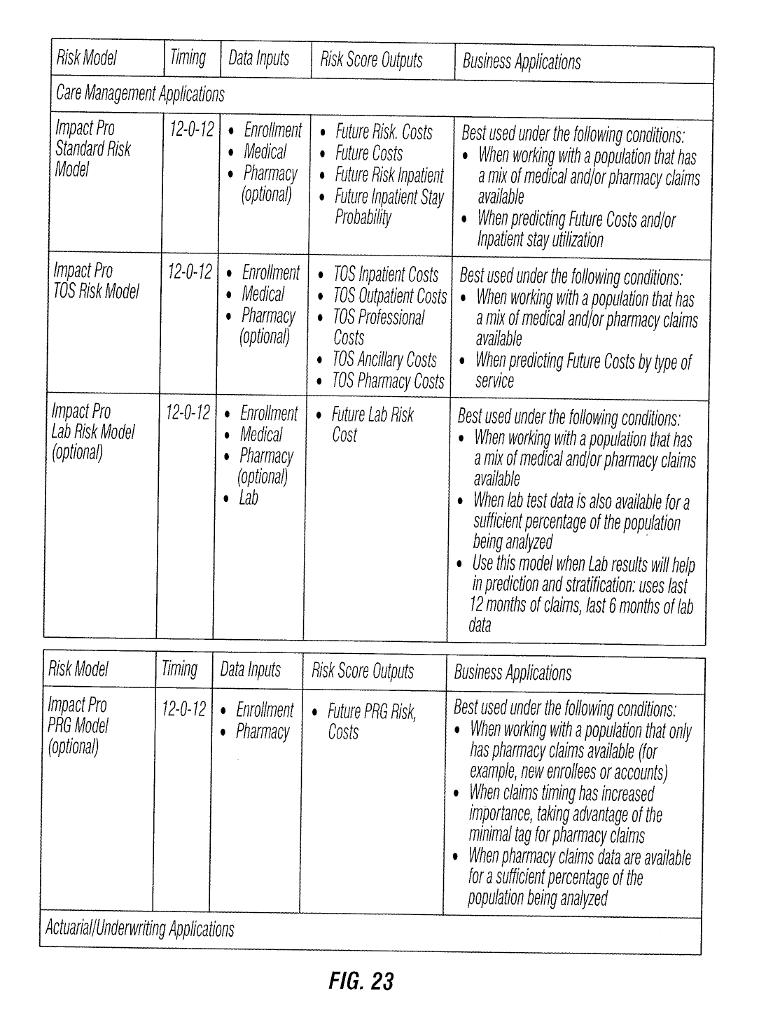

In particular, the Episode Treatment Groups (ETGs™) can serve as a methodology and a building block of the predictive modeling tool. ETGs are a basic illness classification methodology that combines medical and pharmacy services into mutually exclusive and exhaustive categories called episodes of care. In certain embodiments, approximately 600 unique episodes of care are defined—each categorized into one of 22 Major Practice Categories (MPCs), shown in FIG. 25

A number of features of episodes of care and ETGs have importance for their use in a predictive model. By assigning individual medical services to unique episodes of care and characterizing those episodes, ETGs may define clinically-based units that can be combined to construct a profile of risk for an individual. Further, an important construct of an ETG is its ability to prioritize related medical conditions, which may allow for focusing on that condition that may best describe the mix of services required for the ongoing evaluation, management, and treatment of an episode of care. For example, for incidental diagnoses, rather than indicate a separate incidence of a new condition, ETGs may combine these services into the episode for the underlying, primary disorder. In this way, ETGs may perform a complex, hierarchical grouping of conditions that provides a “filter” for characterizing markers of patient risk. Finally, ETGs can link both medical and pharmacy services to diagnostic conditions, allowing prescription drug data to contribute to the measurement of health risk.

In summary, using episodes of care rather than a list of a member's individual diagnoses may provide several advantages such as, but not limited to: (1) Focusing on key information describing a patient's underlying clinical conditions—those conditions best describing the patient's relative risk; (2) Linking both medical and pharmacy services to the diagnosis and treatment of a condition, allowing for measures of condition severity; (3) Comprising clinically based units that can be combined to construct an individual's profile of risk—a profile that supports an understanding of the key conditions responsible for the member's level of risk, and the patterns of use in the member's treatment.

Risk Markers

The markers used in the predictive modeling tool may describe the key clinical conditions for a member and other factors that influence future risk. These markers may include the following types: base markers, medical service markers, pharmacy service markers, and age-sex demographic markers.

Base markers may describe a member's mix of diseases and conditions and are determined using the member's episodes of care and other diagnostic information. Service-based markers derived from the medical and pharmacy services may be assigned to those and capture relevant utilization related to a disease or condition. The base markers may identify a patient with a given condition. The service-based markers can supplement the base markers and may provide an indicator of differences in patient severity within that condition.

The predictive modeling tool may use base markers to describe a member's mix of clinical conditions. Many of these markers may derive from a member's Impact Clinical Categories (ICCs). The predictive modeling tool may use ETGs and other categorizations for this purpose and may combine episodes and other conditions with similar clinical and risk characteristics into the same group. Members having one or more of the ICCs in a group may be assigned the base marker for that group. Using this approach, a total of approximately 130 base markers may be identified. Examples include: AIDS, HIV, CHF, with co-morbidity; benign hypertension, and other endocrinology.

Base markers may also focus on a small number of higher risk, chronic conditions. Patients with these conditions may be identified and categorized separately from other patients with the same mix of episodes. Categorizing patients with these conditions separately may provide a more accurate measurement of future risk and a more relevant description of the key factors underlying risk. Examples of these higher risk ICCs include ALS, cystic fibrosis, and multiple sclerosis.

Finally, for some clinically related base markers, hierarchies may be applied-allowing focus on a single clinical condition most responsible for future risk. This step may permit additional focus on those ICCs best describing a patient's underlying medical condition within a disease category. For example, a patient with both coronary artery disease (CAD) and congestive heart failure (CHF) activity would only receive a base marker for CHF.

Medical service markers may describe the prior use of medical services for a member related to the clinical condition described by a base risk marker. These markers may reflect both the nature of the services provided and their relative timing. In particular, the predictive modeling tool may use two key categories of medical service markers: higher-acuity event markers and episode cluster markers.

The higher-acuity event markers may describe an acute care inpatient stay or emergency room (ER) encounter during treatment of a condition. The predictive modeling tool may use three types of higher-acuity events.

The first type of higher-acuity event is an acute care inpatient event where the primary condition treated (that is, the primary reason for the inpatient stay) is mapped to the base risk marker. For example, an inpatient stays for diabetes where the inpatient admission is part of a diabetes episode of care.

The second type of higher-acuity event is an acute care inpatient event where a secondary condition treated is mapped to the base risk marker. For example, an inpatient consultation for diabetes during an inpatient stay for CHF is a service that could trigger this type of marker.

The third type of higher-acuity event is an emergency room (ER) visit where the primary condition treated is mapped to the base risk marker.

In addition to event type, higher-acuity markers may be differentiated based on event timing. In particular, for some base risk markers a more recent event (within the most recent 3 months) triggers a different risk marker than one occurring at an earlier time (recent 4-12 months). Not all base risk markers and event types may be treated in this way. For some, timing does not matter—earlier and later events trigger the same risk marker. For others, higher-acuity events are not used at all due to their limited impact on future risk.

Finally, a patient presenting more than one of the potential higher acuity event markers for the same base risk marker may be assigned only one of those markers—the marker ranked highest in a predetermined hierarchy. A recent inpatient stay, where the primary condition treated is mapped to the base risk marker is first in the hierarchy, while ER visits are ranked lowest.

In summary, for some base risk markers, higher-acuity events indicate greater risk and are specified as separate markers of risk. Of those base risk markers where higher-acuity markers are used, the type and timing of the event can have an impact on risk. Where multiple higher-acuity markers for the same base risk marker are observed, a hierarchy is applied—only the event marker highest ranked in the hierarchy is ultimately assigned.

Episode cluster markers are the second category of medical service marker that the predictive modeling tool may use. Episode cluster markers may describe the presence of significant physician-related activity for a patient within the episodes of care grouped to a base risk marker. Generally, ETGs identify these clusters as part of the process of building episodes of care. Clusters are the basic unit of an episode. For example an office visit, diagnostic tests, and one or more prescriptions can form a cluster.

Clusters can be created using anchor records—services provided by a clinician engaging in the direct evaluation, management and treatment of a patient. For example, office visits, inpatient stays, therapies, and surgical procedures. Clusters can also include ancillary records, services incidental to anchor records. X-rays, pharmaceuticals, and lab tests are example types of ancillary records. After anchor and ancillary records are assigned to clusters, clusters can be grouped to form episodes of care. So, in order to create an episode cluster, an anchor record, a service performed by a clinician or a facility room and board service, may be required. A patient with a significant number of clinician interventions will have a greater number of anchor records and episode clusters.

The predictive modeling tool may use cluster frequency for episodes grouped to a base risk marker to create further markers of risk. Three categories of these markers may be used, based on number of clusters observed and their timing: (1) Significant number of episode clusters, within 3 months of end of experience period; (2) Significant number of episode clusters, within 4-12 months of end of experience period; and (3) Moderate number of episode clusters, within 4-12 months of end of experience period.

Patients may not have both of the 4-12 month cluster markers for the same base risk marker. If both are observed, the significant marker may be used over the Moderate marker. Patients may have both the 3-month cluster marker and one of the two 4-12 month cluster markers for the same base risk marker. In the same way not all base risk markers qualify to receive a higher-acuity event marker, some base risk markers do not qualify to receive some or all of the episode cluster markers.

The predictive modeling tool may also define markers using pharmacy claims. These markers may supplement the base and medical service risk markers as a means to either identifying patients with diseases or conditions, or by providing an indicator of severity for patients with the same base risk marker.

The predictive modeling tool may assign pharmacy markers using the presence of a therapeutic agent within an Impact Clinical Category (ICC) mapped to a specific base risk marker. An example of a pharmacy agent identifying a patient for a condition is insulin for diabetes, where no diabetes diagnosis is otherwise observed. Examples of pharmacy markers indicating differences in severity for a condition may include patients identified with major depression who also receive anti-depressant/anti-anxiety medications or a CAD patient also receiving one or more prescriptions for blood agents (coumarin, heparin, antiplatelets, and so on).

Additionally, based on their age and gender, each member may be assigned to an Age-Sex risk marker. Several age groups may used for each gender for this purpose.

### Example

### Base and Medical Service Risk Markers

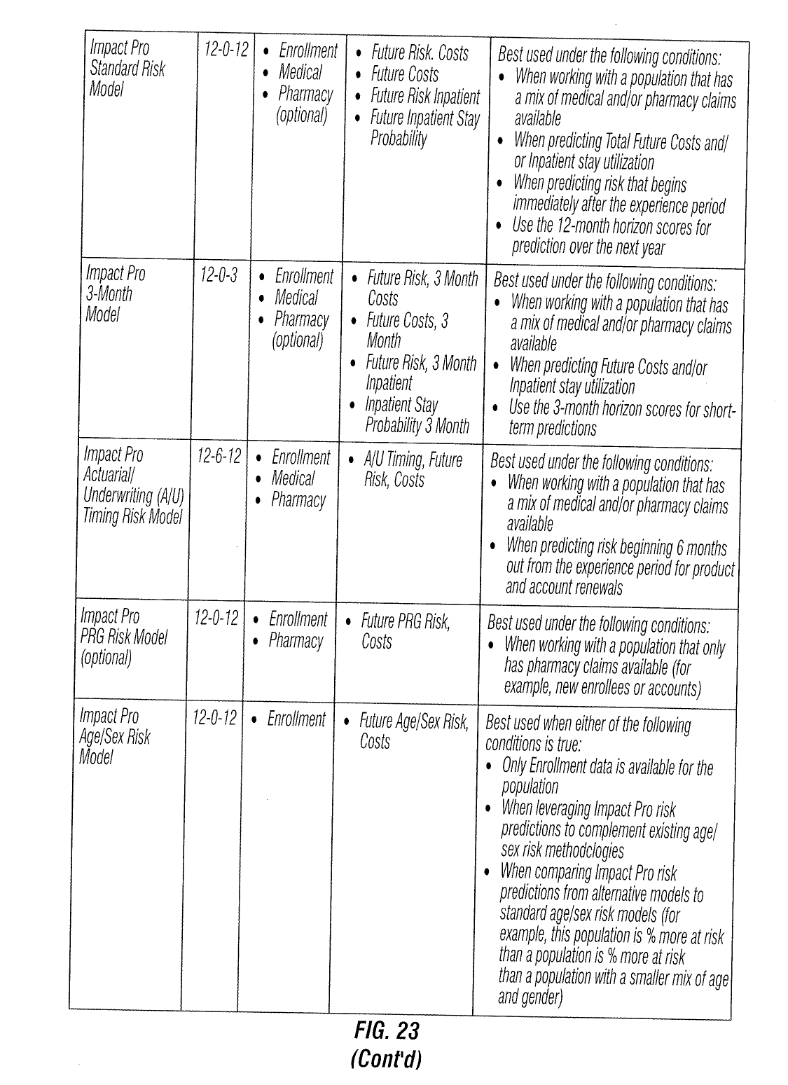

FIG. 26 shows one example of the family of markers for Congestive heart failure (CHF), with a co-morbidity. In this example, all patients observed with CHF, with co-morbidity receive the base marker (08.20.000). Further, depending on the services observed in the management and treatment of CHF, these patients can have zero, one, or more than one of the medical service markers shown, each contributing some amount of risk beyond that assigned to the base.

A patient without any of the listed service markers receives CHF risk equal to the base amount. Note that the ER and secondary inpatient higher-acuity event markers are not used for this base marker—only the primary inpatient markers are included. Also, note how hierarchies are used within each category of markers resulting in only the highest ranked marker in the hierarchy ultimately being assigned.

Measuring the Contribution of Markers to Member Risk

After the predictive modeling tool assigns risk markers for a member, it may weight each marker and uses it to compute a measure of risk. These weights may describe the incremental contribution to risk of having a particular marker. The formula used to compute risk can be described generally as:

Risk_{o,i}=Σb_{r,o}*Marker_{i,r}

where:
Risk_{o,i} is the risk score for outcome o for individual i;
Marker_{i,r} indicates the individual's the predictive modeling tool risk marker (r) assignments; and
b's are the risk weights, one for each marker.

The markers are a series of 0,1 variables, set to 1 if the marker is observed for an individual, 0 otherwise. Each member has their own profile of markers. However, the risk weights for each outcome are predefined and are the same for all individuals. A person's risk score is based on the sum of these risk weights for each marker observed.

The risk weights for the predictive modeling tool may be estimated using data selected from a large managed care population, such as the IHCIS National Managed Care Benchmark Database™. This database includes more than 30 health plans enrolling more than 35 million lives.

Calculating Member's Risk

After the system identifies the risk markers for a member and the weights associated with those risk markers, it may combine markers and the weights to compute member risk for each outcome.

For each member, the predictive modeling tool may produce a measure of future relative risk along with a prediction of future health care costs. It may also assess the member's risk for an inpatient stay and the member's probability of one or more admissions. It may calculate different risk scores for prediction periods that use both a long-term (e.g., 12-month) and short-term (e.g., 3-month) horizon. It may also segment risk into TOS categories.

### Using Cost Multipliers

To calculate costs, the predictive modeling tool may use a cost multiplier, specified in the Processing Engine that translates a relative risk score into a dollar amount. This calculation can be described as:

Future Costsᵢ=12*Cost Multiplier*Future Risk Costsᵢ

where:

Future Costs is the prediction of annual future costs for member i;

Future Risk Costs is the member's relative risk score from the predictive modeling tool; and

The Cost Multiplier represents the annual dollars per unit of risk used to compute annual costs.

In some respects, the predictive modeling tool may use a per-member-per-month (PMPM) cost multiplier obtained from the large managed care benchmark population used to develop the predictive modeling tool—this cost multiplier is consistent with the calendar year level of costs for the population. This cost prediction may be an approximate measure and allows for putting the relative risk prediction in the control of base on cost structure.

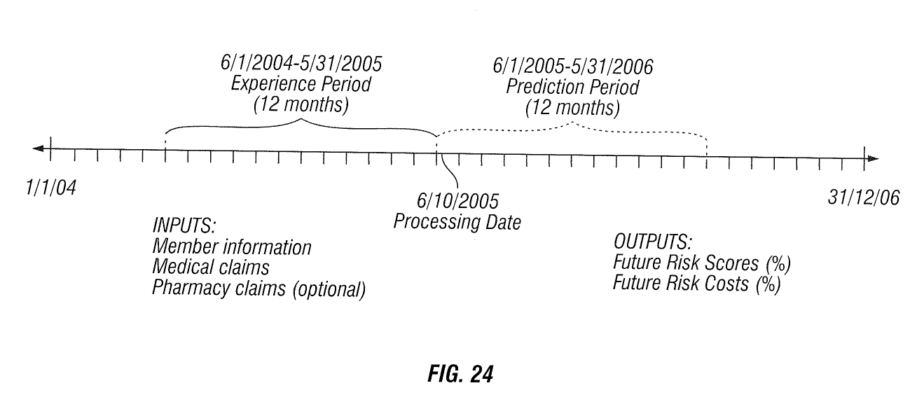

FIG. 27 provides an example of the computation of risk for a member. The individual, i, is a male, age 58. As shown, the member was observed to have ICCs for insulin dependent diabetes, congestive heart failure (CHF), and chronic bronchitis. For each of these conditions, the member receives an amount of risk attached to each base marker. In addition, the member was observed to have a recent inpatient stay for the treatment of diabetes, significant recent CHF activity (clusters) and one or more prescriptions for CHF blood agents. Summing the risk weights across each of these markers, along with the member's age-sex risk weight, produces an overall risk score of 9.9529. This score indicates that the member is expected to have medical and pharmacy costs during the future 12-month period totaling almost 10 times that of the average patient. The average patient in the example is assumed to have an overall risk score of 1.00.

Risk Measures

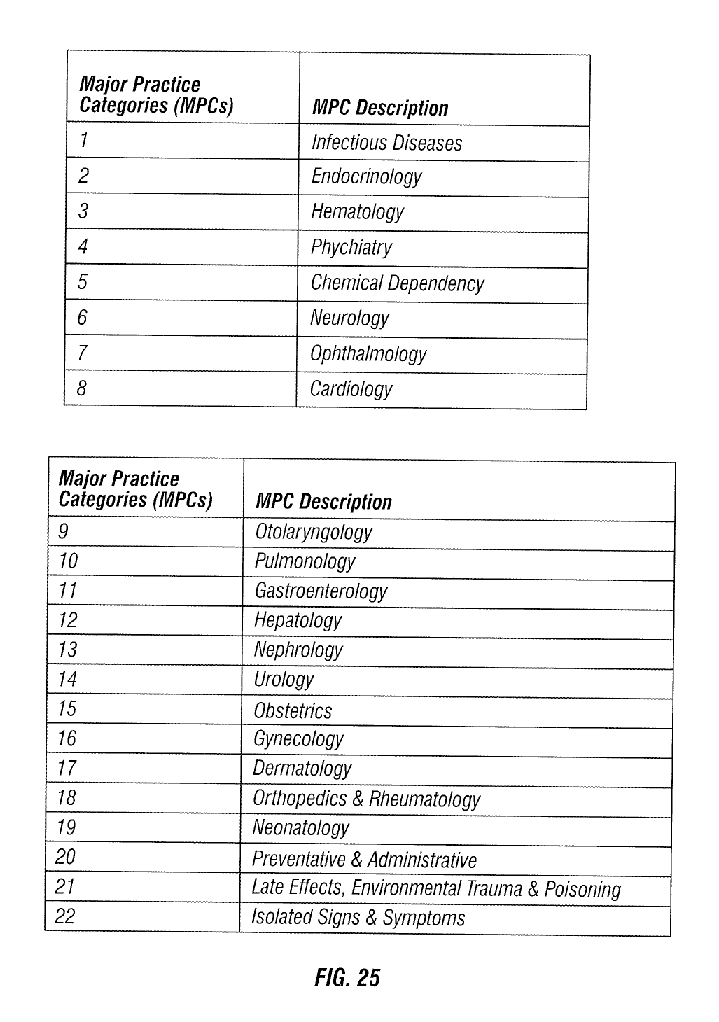

FIG. 28 describes an exemplary list of the risk measures, or scores, that the Standard risk model can provide as outputs. It is noted that other risk models such as a 3-month model, 6-month model, 12-month model, etc., may also be used.

A/U Model

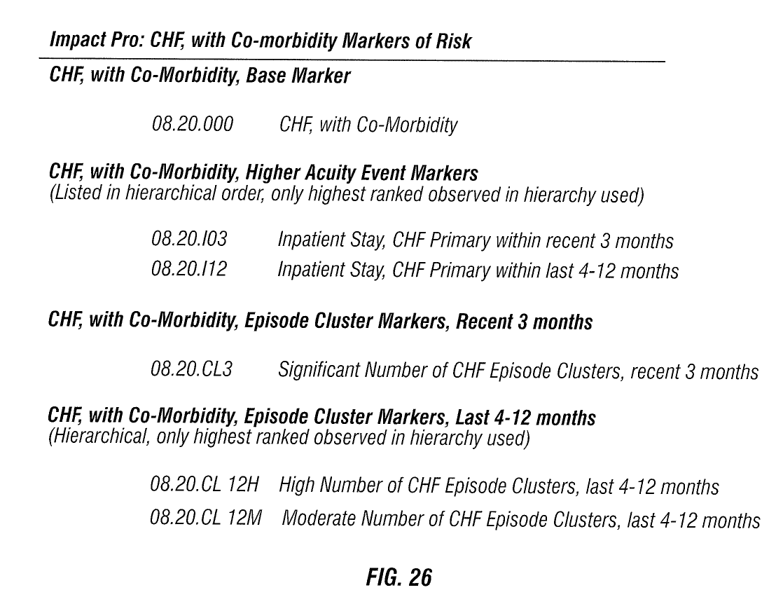

In some embodiments, an actuarial/underwriting (A/U) model may be used for providing risk scores for the underwriting practice. As shown in FIG. 29, one feature of this model is that the A/U Timing Risk Model assumes a 12-month experience period for measuring risk, a gap of 6 months, and a prediction period of the 12 months following. It is noted that other suitable time periods may be used.

This model represents a “12-6-12” timing rather than the “12-0-12” timing used in the Standard risk model. For example, using claims and enrollment for the 12-month period ending June 2005, the Actuarial/Underwriting (A/U) Timing Risk Model provides a prediction of risk targeted for calendar year 2006. While the 12-0-12 model works well for case management applications, in other applications, in particular those involving actuarial and underwriting, additional time is required between the experience period to be used in measuring risk and the future time period to be predicted. For example, to develop a premium for a group, underwriters may typically collect prior enrollment and claims experience for a 12-month period of time and then allow additional time for claims lag and time to complete the analyses involved. The outcome of this process is then used to develop a premium for that group for a future 12-month period that begins 5 to 8 months following the initial 12 months used to collect the prior experience. Again, other suitable time periods may be applicable.

The weights used to calibrate this A/U model differ from those used in the Standard risk model—to reflect the alternative timing for the prediction period. In addition, the weights reflect the number of months for which the member was enrolled during the experience period. On average, a member's risk score decreases as the number of months enrolled during the experience period decreases from 12 to 1. Although this factor may not have a great impact on the member's medical management, it can have an impact on the member's risk and can be important to actuaries and underwriters. The A/U risk model may reflect partial enrollments by applying separate sets of weights in computing risk, depending whether the member was enrolled during the following four periods: 1 to 3 months; 4 to 6 month; 7 to 9 months; and 10 to 12 months.

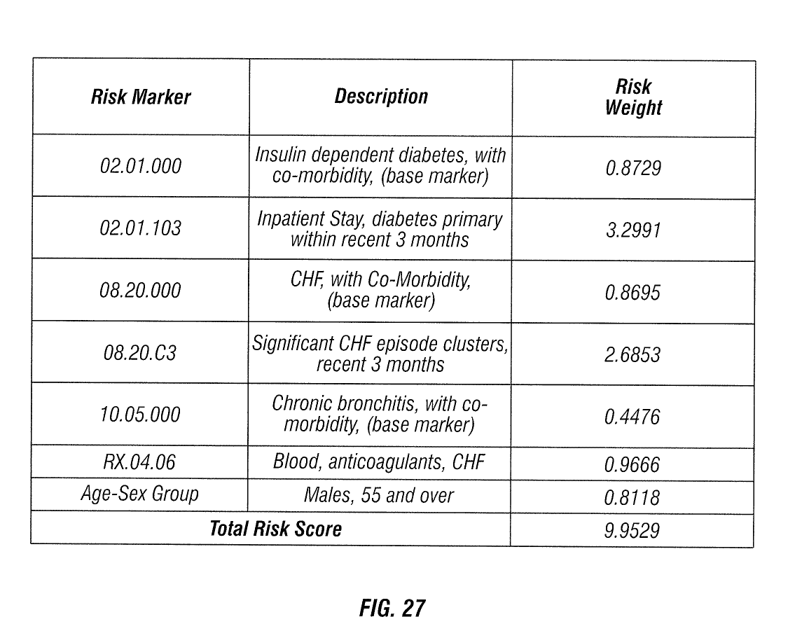

A brief description of these exemplary processing tasks includes input data used to compute risk which may include, without limitation: (1) member enrollment information; (2) medical claim data elements; and (3) pharmacy claim data elements. Processing tasks may also include group Impact Clinical Categories (ICCs). The system may group claims into unique episodes of care and other ICCs. Other processing tasks may include assigning risk markers to each member. Still other processing tasks may include the application of weight markers and calculation of member risk. The system may apply A/U risk model weights describing the contribution of each marker to overall patient risk. The weights may differ depending on the data available for deriving predictions (for example, medical, and pharmacy claims) and the length of the member's enrollment. Then the system may combine the member's array of markers and the weights associated with those markers to compute member risk. Processing tasks may also include an output of risk profile or risk measures, such as that shown in FIG. 30.

Age-Sex Risk Model

The predictive modeling tool Age-Sex risk model can use demographic data, based on member enrollment data, rather than claims-based data. This risk model is part of the base product. This age-sex model may allow the calculation of demographic-based health risk, using, for example, the following categories: Age 0-5; Age 6-11; Age 12-18; Age 19-34; Age 35-44; Age 45-54; Age 55-64; Age 65-74; Age 75-84; Age 85-94; Age 95 and Over.

An age-sex based risk score is produced for each member using the following approach:

AgeSexRiski=Σfₛ*asex_{i,s}

where: AgeSexRiskᵢ is the age-sex-based risk score for person i; asex_{i,s} indicates their age-sex category; and f's are the risk weights for the age-sex model.

The age-sex markers can be represented as a series of 0,1 variables, set to 1 if the marker is observed for an individual, or 0 if not. Each member may be assigned to a single age-sex category.

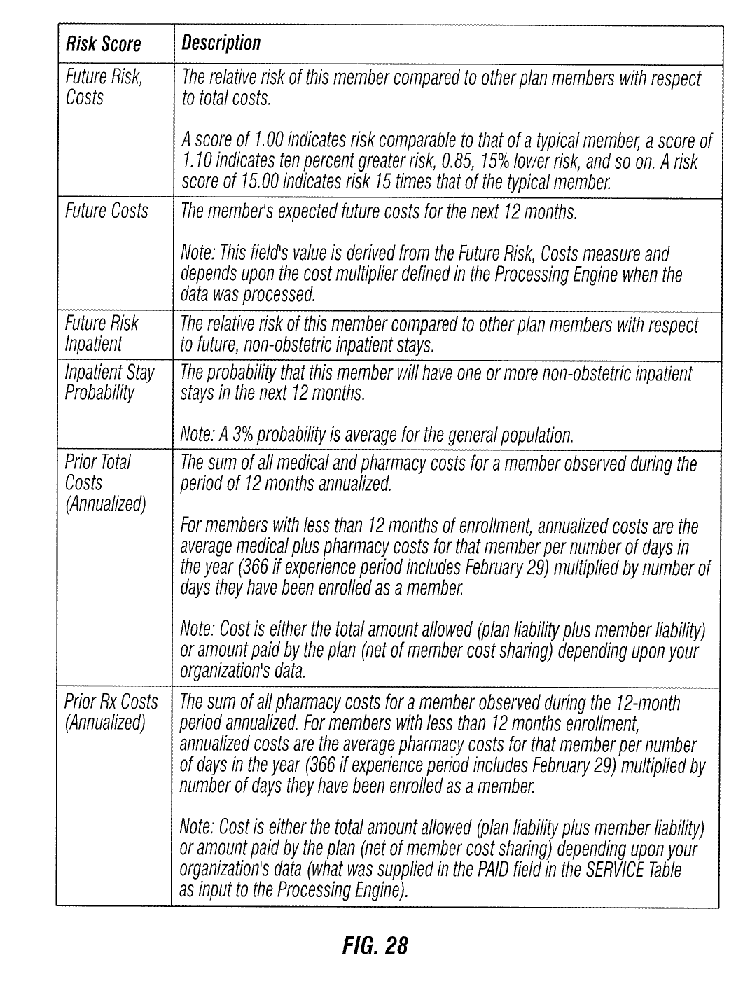

FIG. 31 describes an example of the risk measure, or score, that the Age-Sex risk model provides as outputs.

Type of Service (TOS) Model

The predictive modeling tool Type of Service (TOS) risk model may use information readily available from administrative systems. In effect, it may break down the Standard risk model risk calculations into type of service (TOS) classifications. Thus, instead of using an overall risk score for a member, such as Future Risk Costs, the risk score may be separated into its TOS components, and the type risk is associated with inpatient, outpatient, professional, ancillary, and RX services may be observed.

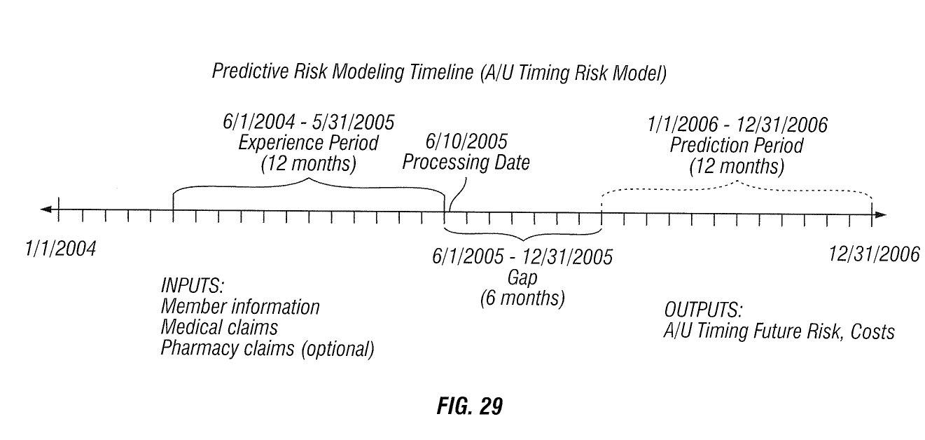

FIG. 32 describes an example of the risk measures, or scores, that the TOS risk model provides as outputs.

Pharmacy Risk Group (PRG) Model

The predictive modeling tool's Pharmacy Risk Group (PRG) risk model may use a patient's pharmaceutical prescriptions and demographic information to assess their prospective health risk. The PRG risk model may be available when a user licenses the predictive modeling tool's optional PRG module.

The fundamental building blocks of the PRG methodology may include a patient's mix of pharmacy prescriptions—the unique occurrences of a drug used in treating a disease or condition and how that agent relates to other agents prescribed for the patient. The nature and mix of these treatments may provide a pharmacy-based profile for a patient that can serve as a marker of their future need for medical care. The PRG risk model may provide an additional risk score for each member and a profile of their pharmacy-based markers of risk. Using this information, along with the other outputs from the predictive modeling tool, a more complete understanding of health risk for a population, as well as a profile of that risk may be achieved. PRGs may be designed to assist organizations that do not have access to complete and consistent medical claims or want to perform more timely health risk assessment. This model's short claim lag and completion time can allow users to assess member's health risk in a timely manner without waiting.

This risk model may be used to assess risk for new members. Many patients fill their prescriptions on a regular basis, either monthly or bi-monthly, at a more frequent rate than that in which they visit their PCP or specialist. Pharmacy data may provide a potential source of information for identifying newly enrolled members with chronic or higher risk conditions sooner—before the utilization and diagnostic information from medical claims may be observed.

The PRG risk model may use a slightly different processing methodology than the Standard risk model to measure patient risk, including, for example:

(1) Input: The input data may include, for example, member enrollment information and pharmacy claim data elements. (2) Assign DCCs: Drug Code Hierarchy—Using the NDC codes recorded on pharmacy claims and a drug code hierarchy developed by, for example, Symmetry Health Data Software, Inc., each pharmacy service for a member may be first assigned to a unique drug class called a DCC. (3) Assign DCC-related PRGs—DCCs for a member can be further categorized into one of 107 initial pharmacy risk groups (PRGs). The PRGs may be markers of member risk and combine DCCs of similar clinical and risk characteristics. (4) Assign Additional PRGs—further PRGs can be defined based on demographics and the combination of initial PRGs observed. These PRGs may reflect comorbidities or other characteristics that suggest a patient is of higher risk. (5) Compile PRG Risk Profile—Age, gender, and a mix of PRGs may provide a clinical and demographic risk profile for a member. Members may be assigned zero, one, or more PRGs. Members with pharmacy treatments that indicate multiple medical conditions may have multiple PRGs. (6) PRG Risk Score—Using pre-determined weights and a member's PRG profile, a risk score may be computed. A member's risk score may be the sum of the weights attached to each PRG and demographic characteristic observed in their profile.

The predictive modeling tool Pharmacy Risk Group (PRG) Module may use a robust, clinically-based and hierarchical system to classify drugs. For example, National Drug Codes (NDCs) on a member's pharmacy claims may provide a detailed description of their particular agents prescribed, including the labeler (manufacturer, packager, or distributor), the product itself (with strength, dosage and formulation), and how the drug is packaged. The key information for health risk assessment may be the general description of the agent itself that can be linked to a therapeutic usage, along with the types of diseases and conditions for which the agent is typically prescribed. If a strong link can be established between an agent and therapeutic usage, the drugs prescribed for a member may serve as a useful proxy for their overall morbidity and health risk.

The predictive modeling tool's PRG Module may map all NDC codes for a patient to a unique Drug Class Code (DCC). It is noted that in one embodiment PRGs assume a 12-month risk marker period for a member, although other suitable time periods may be used. All available pharmacy claims for a given time period for a member may be used for mapping to DCCs and creating markers of risk.

Drug Class Codes (DCCs) may subsequently be combined into larger groups to create PRGs. By mapping DCCs to PRGs, drugs of similar clinical and risk characteristics may be combined. The mapping may involve a number of steps and assumptions, such as, but not limited to the following.

DCCs indicating the same disease or condition and patients of similar risk can be combined. To enhance both clinical relevance and also homogeneity in terms of risk, the grouping of DCCs may occur primarily within the same PCC and TCC—with all agents in most PCCs assigned to the same PRG. Exceptions may include agents typically used to treat clinically diverse patients, patients of differing risk, or both. In these cases, some DCCs within the same PCC may be assigned to separate PRGs.

DCCs with relatively low prevalence may be combined with other DCCs based on clinical similarity and implications for risk assessment.

PRG assignment may not be dependent on the number of DCCs or prescriptions observed for an individual within the same PRG. Patients with one or more agents or prescriptions within a PRG may receive identical assignments. Further, for practical and other reasons, measures of dosage recorded on pharmacy claims, such as days supply and metric quantity, may not have an impact on PRG assignment.

Not all DCCs may be used. Many agents have no measurable impact on future risk for a patient and are not assigned to a PRG. Further, to promote consistency, pharmaceutical agents not typically covered and provided through a prescription drug benefit may not be used. Agents administered largely in an inpatient or facility setting or distributed mostly over-the-counter are examples of drugs that do not affect PRGs.

Additional PRGs may be defined based on observed combinations of the PRGs. The majority of these added PRGs may be designed to capture the impact on risk of a patient's co-morbidities. For example, a patient prescribed agents related to the treatment of coronary artery disease (CAD) who also has one or more prescriptions for insulin (suggesting diabetes) may have a different level of risk related to these agents than a patient with only the CAD agent or only insulin. A patient receiving a CAD-related agent with multiple co-morbidities is another example. For selected agents, separate PRGs may also be defined depending on whether the patient was 0-18 years or greater than 18, based on a differing impact on risk for children and adults. Glucocorticoid agents are one example.

The PRG Profile may be a clinical and demographic member profile comprised of, for example, a member's age, gender and mix of PRGs. Several age groups may be used for each gender for this purpose, such as 0-5, 6-11, 12-18, 19-34, 35-44, 45-54, and 55 years of age and older.

Every member may be assigned to an age-sex group. Members may also be assigned to zero, one, or more PRGs depending on their mix of pharmacy agents. Members with pharmacy treatments that indicate multiple medical conditions may have multiple PRGs. Conversely, members without pharmacy claims will have no PRGs, where the risk for these members may be based solely on the age and gender component of the model.

The predictive modeling tool may assign a weight to each PRG and demographic marker of risk to calculate health risk for each member. The PRG risk model may use predetermined weights and a member's PRG Profile to calculate a risk score. The PRG weights may use in computing risk describe the contribution to risk of being in a specific age-sex group or having a particular agent included in a PRG. The model of risk may be defined as:

Riskᵢ=Σas*asex_{i,s}+Σbₑ*PRG_{i,p}

where:

Riskᵢ is the PRG risk score for person i;

asexᵢₛ and PRG_{i,p} indicate their age-sex group (s);

PRG (p) are assignments; and

the a's and b's are the risk weights.

The age-sex and PRG markers may be a series of 0,1 variables, set to 1 if the marker is observed for an individual, 0 otherwise. The risk weights for the PRG risk model may be estimated using data selected from the same large managed care population used to develop the Standard risk model. The risk weights for PRGs may be calculated using multiple linear regression and recent enrollment and pharmacy claims data for a large population. The weights may represent the relative costs per member per month (PMPM) associated with being in a specific age-sex group or having a particular medical condition indicated by a PRG—each marker's contribution to risk.

The predictive modeling tool PRG Risk Model may provide an additional risk score for each member based on pharmacy claims information. Outputs from the PRG module may include a measure of future health risk for the entire member population and/or a list of the PRGs observed for each member.

In certain embodiments, the PRG risk model provides as outputs the relative risk of a member compared to other plan members with respect to total costs. The measure of risk may be calculated using the PRG model that uses a member's pharmacy data as input.

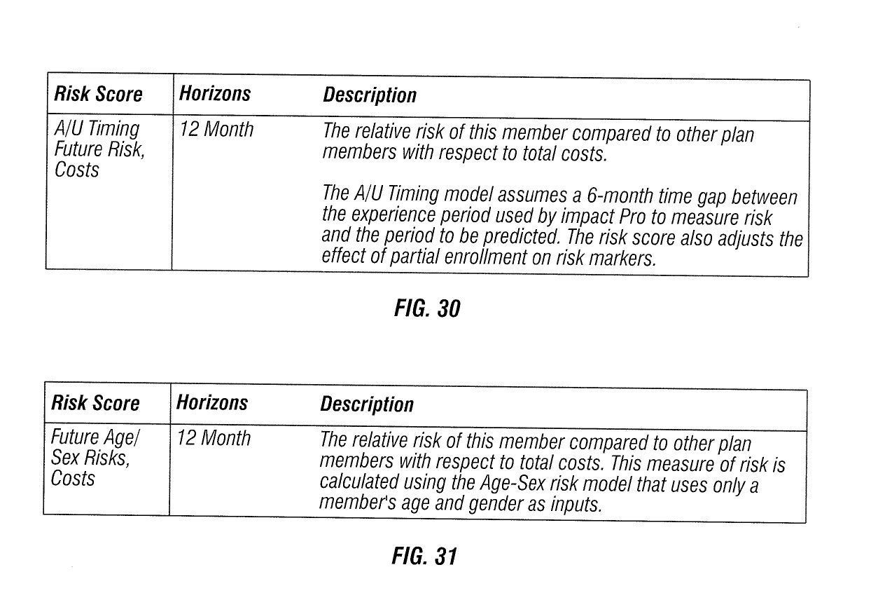

FIG. 33 provides examples of how to calculate PRG risk for an individual of a member population. The individual's age and sex and the listed PRGs describe the individual's profile of risk. The sum of the weights assigned to these risk markers may provide the overall risk scores for the individual.

Example 1 shown in FIG. 33 shows how, over a 12-month period, a male, age 58, was observed to have six unique DCCs that map to four different PRGs: quinolones, antihypertensive agents, selected antiinfectives (macrolides), and antidepressants/antianxiety. The Total Risk Score reflects each individual's overall measure of risk relative to that of the population used in developing PRGs. A score of 1.00 may indicate a risk comparable to that of the development population, a score of 1.10 may indicate a 10 percent greater risk, 0.85 may indicate a 15 percent lower risk, and so on.

The 58-year-old male described in FIG. 33 has a PRG prospective risk score of 2.246, indicating a level of future health risk more than two times that of the average.

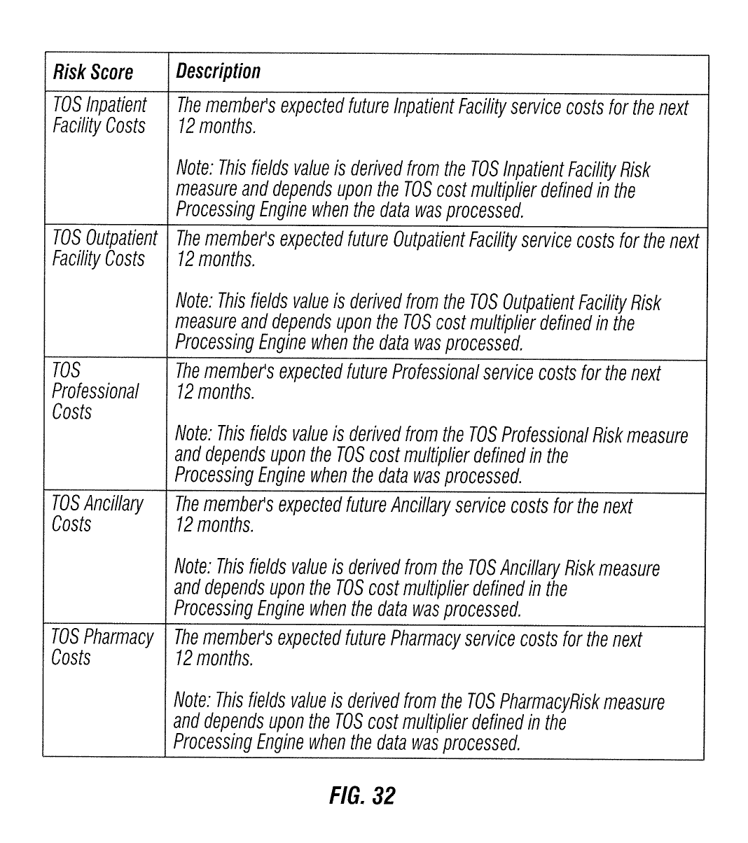

Example 2 in FIG. 34 shows a male, age 58, whose prescription drugs translate into two unique DCCs that map into two initial PRGs. These initial PRGs combined trigger a third PRG, based on the presence of both the carvedilol and insulin agents. This member receives separate risk weights for the carvedilol and the insulin PRGs and also receives a third weight due to the co-morbid PRG. Relative risk for this patient is 3.9116—indicating a level of future health risk almost four times that of the average member.

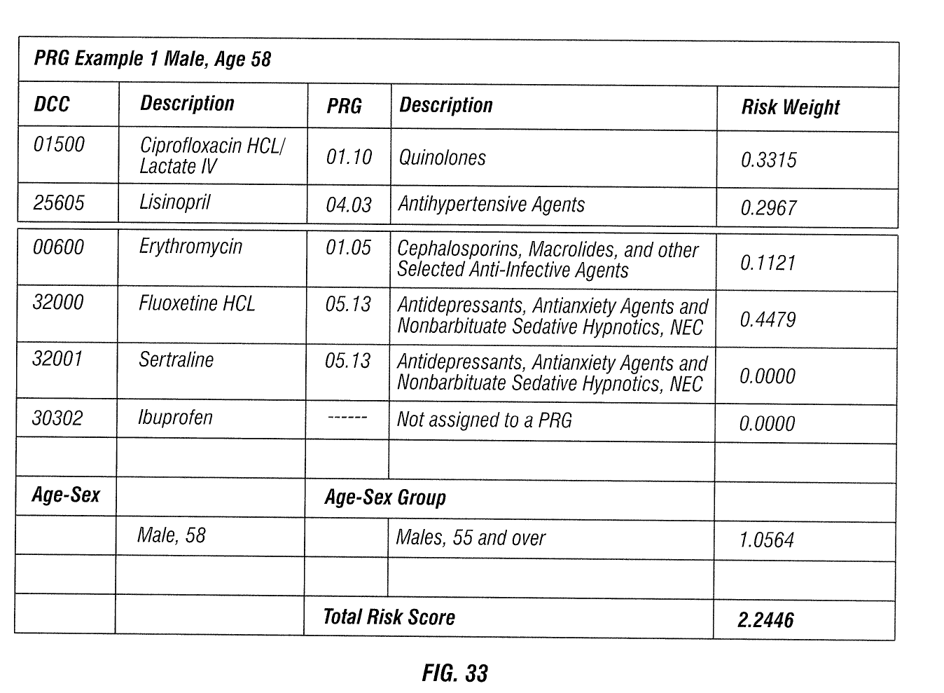

Example 3 shown in FIG. 35 describes a 52 year old female with two DCCs. The first DCC, riluzole, maps to the PRG for agents used in the treatment of ALS. The second DCC describes an antidepressant. The risk weights assigned to these PRGs, along with the age-sex weight for the member, produce an overall risk score of 11.1630, more than eleven times that of the average member for this example.

Lab Risk Models

The predictive modeling tool's Lab risk model may employ both administrative claims data and clinical lab results in risk prediction. It may allow users to incorporate lab test results into the predictive modeling process.

The predictive modeling tool focuses on those tests providing the most value to high-risk patient identification. To do this, lab tests may be categorized in terms of their potential value for predictive modeling: (1) Acute, “time-sensitive” information; (2) Information confirming a diagnosis; (3) Information regarding disease severity, progression, and co-morbidities; and (4) Information for “longer” term predictions.

In general, those tests described by the second and third categories may be most useful for prediction. Lab results in the fourth category may also have use in identifying patients for appropriate interventions. When combined with other administrative claims and medical information, lab results data improve predictive accuracy by generating additional markers of risk.

The Lab risk model, like the Standard risk model, may use enrollment, medical, and pharmacy claims from the past 12 months to apply risk markers, although other time periods may be suitable. In addition, it may use clinical lab test results from the past 6 months to create additional lab test-related risk markers. These data may include a description of the test, the date the test was performed, the test result, and the metric used to measure the result.

The Lab risk methodology may involve the following tasks to measure patient risk: (1) Inputting data; (2) ICC grouping; (3) Assigning episode-based markers; (4) Assigning lab-based risk markers; (5) Weighting of a profile to compute risk; (6) Completing member risk profile; (7) Generating outputs.

The input data can include member enrollment information, lab results (for example, for the past 6 months), medical claim data elements (for example, for the past 12 months), and pharmacy claim data elements (for example, for the past 12 months).

The claims may be grouped into unique episodes of care and Impact Clinical Categories (ICCs). These episodes may describe a member's observed mix of diseases and conditions and underlying co-morbidities and complications. Episode-based markers may be assigned as base markers of co-morbidity. The ICCs for each member may further be grouped into homogeneous risk categories, called base markers. Hierarchies and other algorithms may be applied to optimize this grouping. Demographic markers of risk may also be created during this step describing a member's age and gender.

Lab-based risk markers may be assigned in certain examples. For some lab tests, a result outside of the normal range may serve as an indication that a patient's level of risk differs from that of other patients with a similar mix of clinical conditions. For these tests, the predictive modeling tool may use the categories of test results and trend indicators to create lab-based markers of risk. These markers may be defined using the result value range for the test finding and the timing of the test (e.g., within the most recent 90 days versus the most recent 91-180 days). For some lab tests, trend indicators may also be used to create markers. In certain embodiments, a total of 72 lab-based markers of risk may be defined in this way.

The condition, service, and lab risk markers for each member may be arrayed to create a risk profile. This profile describes for each member whether they were observed to have (or not have) each of the 72 lab-based markers of risk. Members may have zero, one or more of these markers. Members without lab test results or without a lab test result that triggers a marker of risk may not have any of these markers.

In addition to the lab-based markers, the Lab risk model may use the approximately 450 risk markers defined using medical and pharmacy claims for this embodiment. By combining the claims-based and lab-based markers of risk, more than 500 markers may be included in the Risk Profile for this model.

A weighting of the profile may also be used to compute risk. A risk weight may be applied to each marker describing its contribution to overall patient risk. These weights may be derived using experience from a large managed care population. As with the Standard risk model, the weights may differ depending on the claims data available for deriving predictions (medical and pharmacy claims versus medical claims only).

In certain embodiments, completing a member risk profile may comprise the calculation of member measures of health risk.

Certain embodiments may also comprise generating outputs where the risk results and other information describing the member's lab based markers of risk may be assembled to support the predictive modeling tool data marts, reports and reporting application. The risk weights may describe the incremental contribution to risk of having a particular marker. The formula used to compute risk can be described as:

Risk_{L,i}=c_{r,L}*Marker_{i,r}+d_{s,L}*LabMarker_{i,s}

where:

Risk_{L,i} is the lab-based risk score (L) for future costs for an individual (i);

the c's and d's indicate the predictive modeling tool Lab Risk Module risk weights, there is one for each marker;

Marker i,r indicates the individual's (i) enrollment and claims-based Predictive modeling tool risk marker (r) assignments from the Standard Model; and

LabMarker_{i,s} indicates the individual's lab-based the predictive modeling tool risk marker (s) assignments.

Outputs from the predictive modeling tool Lab Risk module include a measure of future risk for (Future Lab Risk, Costs) and a summary of a patient's recent lab history and how these lab findings relate to normal ranges. Future Lab Risk, Costs comprises the relative risk of a member compared to other plan members with respect to total costs. The measure of risk may be calculated using the clinical lab results in addition to medical and pharmacy data as inputs.

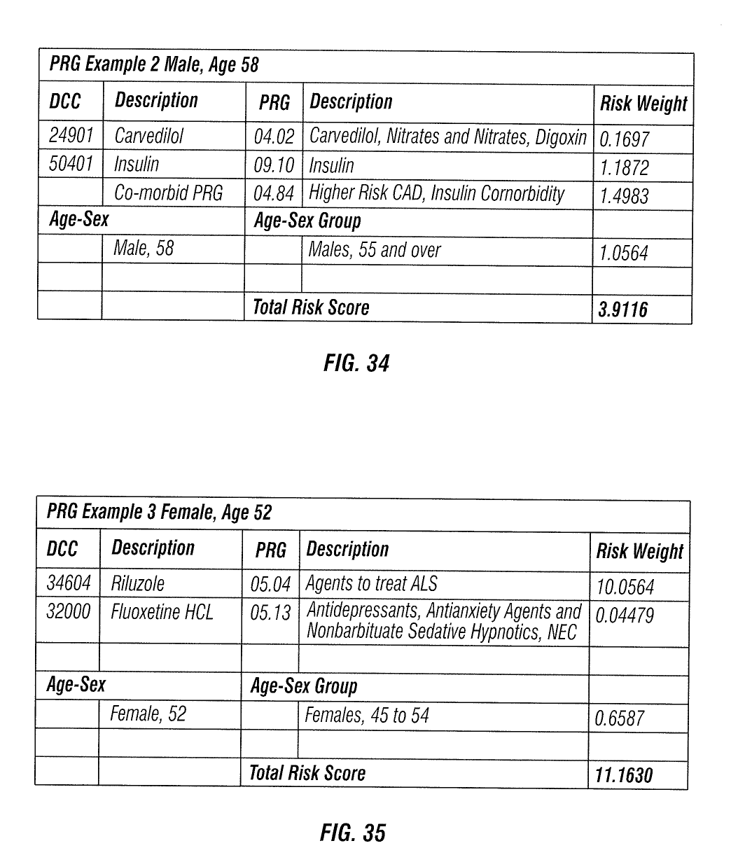

FIG. 36 includes examples of some of the lab-based markers of risk used by the predictive modeling tool lab risk model. As shown, in addition to a description of the test itself, these markers may capture information related to the lab results value, its relationship to the normal range, the timing of the test, and, in some cases, the results trend.

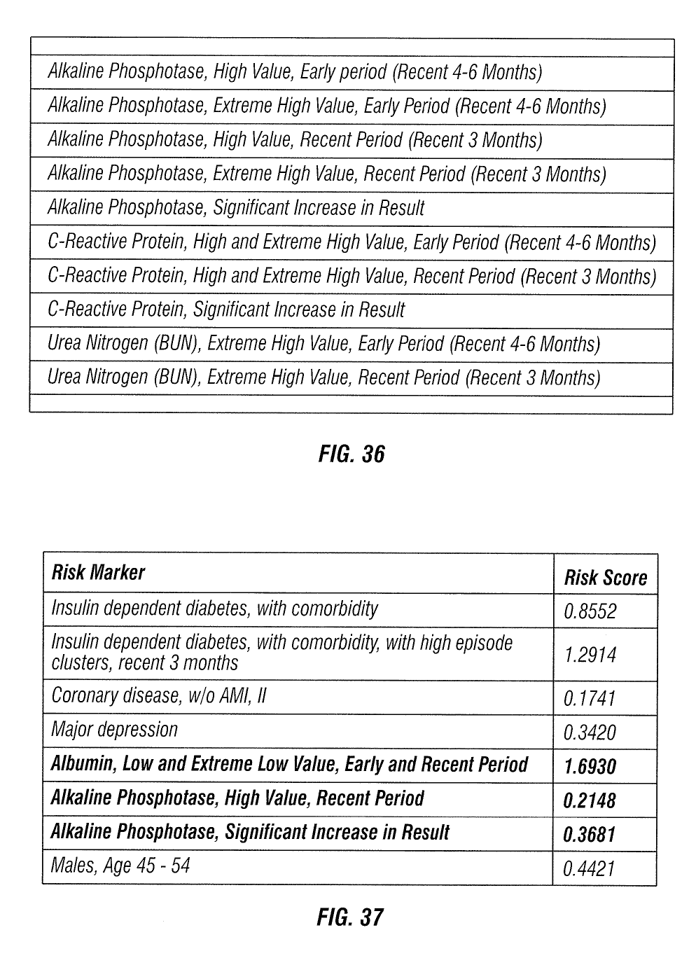

One example of the risk scores assigned to a member using the Lab risk model is shown in FIG. 37. In this example, the system assigns the first few risk markers based on claims data. Several risk markers related to lab results are indicated in bold type. The risk marker for Males, Age 45-54 is based on demographic data.

Output

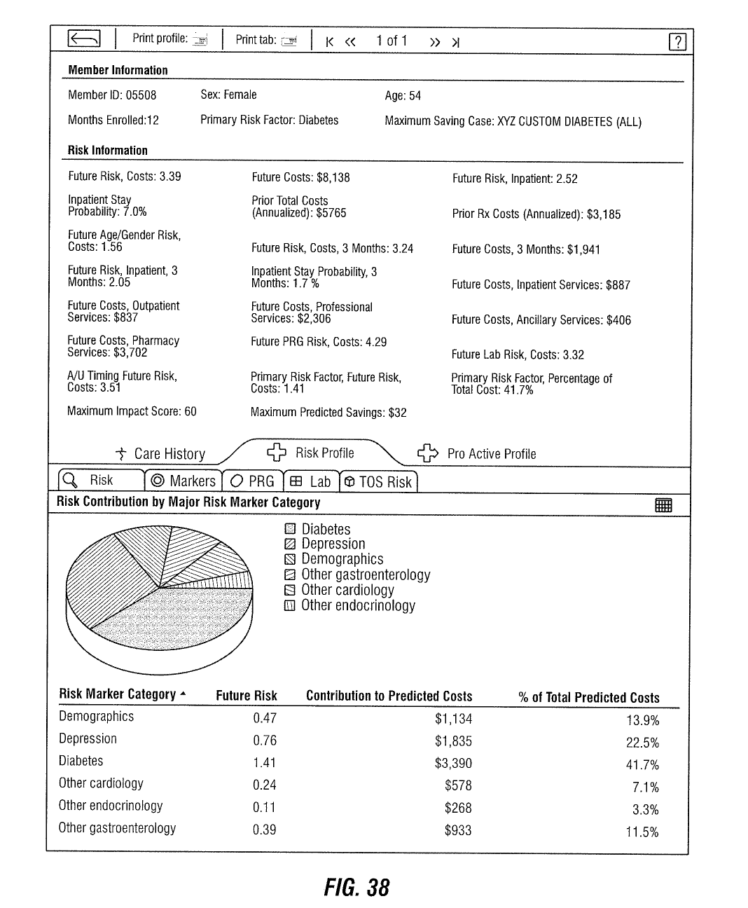

As shown in the exemplary embodiment illustrated in FIG. 38, after a dataset is imported from the Processing Engine to the Reporting System, the Reporting System may display the member's risk measures in the Risk Information section of the member profile. The Reporting System may also display other risk information in the Risk Profile section of the member profile. This information may be viewed onscreen and may be printed as a report. The Risk Profile may include risk information based on one or more risk models.

Features of the present disclosure may be performed using executable instructions. For example, a computer code for implementing all or parts of this disclosure may be used. The code may be housed on any computer capable of reading such code as known in the art. For example, it may be housed on a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc. The computer code may be executable on any processor, e.g., any computing device capable of executing instructions for traversing a media stream. In one embodiment, the processor is a personal computer (e.g., a desktop or laptop computer operated by a user). In another embodiment, processor may be a personal digital assistant (PDA) or other handheld computing devices.

In some embodiments, the processor may be a networked device and may constitute a terminal device running software from a remote server, wired or wirelessly. Input from a source or other system components may be gathered through one or more known techniques such as a keyboard and/or mouse. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The processor may use any type of monitor or screen known in the art, for displaying information. For example, a cathode ray tube (CRT) or liquid crystal display (LCD) can be used. One or more display panels may also constitute a display. In other embodiments, a traditional display may not be required, and the processor may operate through appropriate voice and/or key commands.

With the benefit of the present disclosure, those having ordinary skill in the art will comprehend that techniques claimed here may be modified and applied to a number of additional, different applications, achieving the same or a similar result. The claims cover all such modifications that fall within the scope and spirit of this disclosure

1. A method for underwriting comprising:
receiving authorization from a customer for access to predictive data, the predictive data comprising at least one of pharmacy profile information, lab profile information, and credit information;
retrieving the predictive data;
generating a risk score based on the predictive data;
generating a substantially real-time quote based on the risk score; and
providing the substantially real-time quote to the customer.

2. The method of claim 1 wherein the predictive data comprises pharmacy profile information and lab profile information.

3. The method of claim 1 wherein the predictive data comprises pharmacy profile information and credit information.

4. The method of claim 1 wherein the predictive data comprises lab profile information and credit information.

5. A program storage device readable by a machine, tangibly embodying a program of instructions executable by the machine to perform the method steps of claim 1.

6. A method for underwriting comprising:
receiving authorization to access a pharmacy profile from a customer;
retrieving the pharmacy profile;
generating a substantially real-time quote based on the pharmacy profile; and
providing the substantially real-time quote to the customer.

7. The method of claim 6 further comprising:
generating a risk score based on the pharmacy profile information; and
generating the substantially real-time quote based on the risk score.

8. The method of claim 7, where generating the risk score comprises using a predictive modeling tool to generate the risk score

9. A program storage device readable by a machine, tangibly embodying a program of instructions executable by the machine to perform the method steps of claim 6.

10. The method of claim 6, further comprising receiving authorization from the customer to access medical history information.

11. The method of claim 10, where generating the substantially real-time quote further comprises generating the substantially real-time quote based on the medical history information.

12. The method of claim 1, further comprising receiving authorization from the customer to access credit history information.

13. The method of claim 12, where generating the substantially real-time quote further comprises generating the substantially real-time quote based on the credit history information.

14. The method of claim 6, further comprising receiving authorization from the customer to access lab profile information.

15. The method of claim 14, where generating the substantially real-time quote further comprises generating the substantially real-time quote based on the lab profile information.

16. The method of claim 6, further comprising receiving a questionnaire from the patient.

17. The method of claim 16, where generating the substantially real-time quote further comprises generating the substantially real-time quote based on the questionnaire.
